(19) United States
(12) Patent Application Publication
(10) Pub. No.: US 2013/0325573 A1
(43) Pub. Date: Dec. 5, 2013

(54) METHOD, APPARATUS, AND RECORDING MEDIUM IMPLEMENTING MOBILE APPLICATION MARKETING

(71) Applicants: Marvin PARK, Seoul (KR); Jaeui CHUNG, Seoul (KR)

(72) Inventors: Marvin PARK, Seoul (KR); Jaeui CHUNG, Seoul (KR)

(73) Assignee: NEOWIZ GAMES CORPORATION, Gyeonggi-do (KR)

(21) Appl. No.: 13/564,146

(22) Filed: Aug. 1, 2012

(30) Foreign Application Priority Data
Jun. 4, 2012 (KR) 10-2012-0059621

(51) Int. Cl. G06Q 30/02

(52) U.S. Cl. 705/14.16

(57) ABSTRACT

Disclosed is a method, an apparatus, and a recording medium for implementing mobile application marketing. The mobile application marketing method includes the steps of receiving, by a marketing server, review information regarding a mobile application from a first mobile terminal and storing the received review information together with identification information regarding the mobile application and identification information regarding a marketer who has logged into the first mobile terminal; installing, by a second mobile terminal, the mobile application included in the review information based on the stored review information; and performing, by the marketing server, a process of rewarding the marketer corresponding to the identification information for installation of the mobile application.

### CROSS-REFERENCE TO RELATED APPLICATION

This application claims priority from and the benefit under 35 U.S.C. §19(a) of Korean Patent Application No. 10-2012-0059621, filed on Jun. 4, 2012, which is hereby incorporated by reference for all purposes as if fully set forth herein.

### BACKGROUND OF THE INVENTION

1. Field of the Invention

The present invention relates to a method, an apparatus and a recording medium for implementing the marketing of a mobile application.

2. Description of the Prior Art

Applications (e.g. software, programs) have conventionally been distributed in a limited manner, for example, by being stored in CDs, diskettes, etc., and those who want to use an application had to visit a software store in person and pay the price to purchase an application.

In line with recent development of communication, applications adapted to mobile devices have increased. As a result, methods of purchasing of such applications have been changing from conventional offline purchases to online payments. Such change of purchasing methods enables rapid spread of mobile applications, but makes it impossible to apply conventional marketing methods.

### SUMMARY OF THE INVENTION

Mobile applications can be spread rapidly through mobile terminals, making it necessary to implement a tool supporting a type of marketing suited to this end.

Therefore, the present invention has been made in view of the above-mentioned problems, and an aspect of the present invention is to propose a marketing server adapted to support the mobile application marketing and implementation of a process performed to implement mobile application marketing by the marketing server.

Another aspect of the present invention is to propose a process making it possible to perform marketing on a mobile terminal to support the mobile application marketing.

Another aspect of the present invention is to propose a process for installing the marketed mobile application and making it possible to use installation of the marketed mobile application as a marketing result.

Another aspect of the present invention is to provide a reward for spreading an application to enable accurate marketing based on recommendations from acquaintances and reflect user preferences.

In accordance with an aspect of the present invention, there is provided a mobile application marketing method including the steps of receiving, by a marketing server, review information regarding a mobile application from a first mobile terminal and storing the received review information together with identification information regarding the mobile application and identification information regarding a marketer who has logged into the first mobile terminal; installing, by a second mobile terminal, the mobile application included in the review information based on the stored review information; and performing, by the marketing server, a process of rewarding the marketer corresponding to the identification information for installation of the mobile application.

In accordance with another aspect of the present invention, there is provided a mobile application marketing method including the steps of receiving, by a marketing server, review information regarding a mobile application from a first mobile terminal; storing, by the marketing server, the received review information, identification information regarding the mobile application, and identification information regarding a marketer who has logged into the first mobile terminal; transmitting, by the marketing server, the review information to a second mobile terminal which requests the review information; receiving, by the marketing server, a message indicating that the mobile application has been installed on the second mobile terminal; and performing, by the marketing server, a process of rewarding the marketer for installation of the mobile application.

In accordance with another aspect of the present invention, there is provided a mobile application marketing method including the steps of transmitting, by a first mobile terminal, review information regarding a mobile application to a marketing server; receiving, by the first mobile terminal, a message from the marketing server, after the mobile application is installed on a second mobile terminal which has requested the review information, the message including information regarding a reward for installation of the mobile application; and receiving, by the first mobile terminal, a result of performing a rewarding process based on the reward from the marketing server.

In accordance with another aspect of the present invention, there is provided a mobile application marketing method including the steps of receiving, by a mobile terminal, review information regarding a mobile application from a marketing server; and installing, by the mobile terminal, the mobile application included in the received review information, wherein the marketing server performs a process of rewarding a marketer, who has written the review, for installation of the mobile application.

In accordance with another aspect of the present invention, there is provided a marketing server including a reception unit adapted to receive review information regarding a mobile application from a first mobile terminal; a database unit adapted to store the received review information, identification information regarding the mobile application, and identification information regarding a marketer who has logged into the first mobile terminal; a transmission unit adapted to transmit the review information to a second mobile terminal which requests the review information; and a control unit adapted to perform a process, when the reception unit receives a message indicating that the mobile application has been installed on the second mobile terminal, of rewarding the marketer for installation of the mobile application.

In accordance with another aspect of the present invention, there is provided a mobile terminal including a transmission unit adapted to transmit review information regarding a mobile application to a marketing server; a reception unit adapted to receive a message from the marketing server, after the mobile application is installed on a second mobile terminal which has requested the review information, the message including information regarding a reward for installation of the mobile application; and a control unit adapted to control the transmission unit and the reception unit, wherein the control unit is adapted to control the reception unit so as to receive a result of performing a rewarding process based on the reward from the marketing server.

In accordance with another aspect of the present invention, there is provided a mobile terminal including a reception unit adapted to receive at least two pieces of identification information regarding at least two pieces of review information regarding a mobile application from a marketing server; a transmission unit adapted to transmit one of the at least two pieces of identification information regarding at least two pieces of review information to the marketing server; and a control unit adapted to control so that, when the reception unit receives review information regarding the mobile application from the marketing server, the mobile application included in the received review information is installed, wherein the marketing server performs a process of rewarding a marketer, who has written the review, for installation of the mobile application.

### BRIEF DESCRIPTION OF THE DRAWINGS

FIG. 1 illustrates a system for providing a mobile application according to an embodiment of the present invention;

FIG. 2 illustrates the structure of pieces of information included in a database according to an embodiment of the present invention;

FIG. 3 illustrates a process of rewarding for mobile application marketing according to an embodiment of the present invention;

FIG. 4 illustrates a distribution scheme through app executing during a workflow for performing the viral distribution task of FIG. 3;

FIG. 5 illustrates application of information of the database shown in FIG. 2 to an embodiment of the present invention;

FIG. 6 illustrates a process of creating review information for a marketer to perform a viral distribution task according to an embodiment of the present invention;

FIG. 7 illustrates a detailed example of writing a review according to an embodiment of the present invention;

FIG. 8 illustrates a process of mobile-based promotion of a developed application by an application developing company or developer according to an embodiment of the present invention;

FIG. 9 illustrates a construction enabling differential rewarding based on competition between marketers according to an embodiment of the present invention;

FIG. 10 illustrates a construction of a database for applying the scheme of FIG. 9;

FIG. 11 illustrates a mobile cash transfer process using an online payment service according to an embodiment of the present invention;

FIG. 12 illustrates a process according to an embodiment of the present invention;

FIG. 13 illustrates a process according to another embodiment of the present invention;

FIG. 14 illustrates a detailed process of rewarding for mobile application marketing by a marketing server according to an embodiment of the present invention;

FIG. 15 illustrates a process of performing mobile application marketing on a mobile terminal used by a marketer according to an embodiment of the present invention;

FIG. 16 illustrates a process implemented on a mobile terminal, which checks out a review of a mobile application and installs the mobile application according to an embodiment of the present invention;

FIG. 17 illustrates the construction of a marketing server adapted to reward for mobile application marketing according to an embodiment of the present invention;

FIG. 18 illustrates the construction of a mobile terminal in connection with mobile application marketing according to an embodiment of the present invention;

FIG. 19 illustrates a screen structure of a mobile terminal, on which a marketing application is installed, according to an embodiment of the present invention;

FIG. 20 illustrates a marketing rewarding process according to an embodiment of the present invention;

FIG. 21 illustrates a process of paying out a marketing cost according to an embodiment of the present invention;

FIGS. 22A, 22B, and 22C illustrate a screen after installation of iBee App on a mobile terminal and following login according to an embodiment of the present invention;

FIGS. 23A and 23B illustrate a process of downloading a specific application using iBee App according to an embodiment of the present invention;

FIGS. 24A and 24B illustrate a process of marketing an application using iBee App according to an embodiment of the present invention;

FIGS. 25A, 25B, 25C, 25D, and 25E illustrate a process of controlling buddy information using iBee App according to an embodiment of the present invention;

FIGS. 26A, 26B, and 26C illustrate checkout of personal information by iBee App according to an embodiment of the present invention;

FIGS. 27A, 27B, and 27C illustrate checkout of a reward for review information by iBee App according to an embodiment of the present invention; and

FIGS. 28A, 28B, and 28C illustrate payout of a reward for review information by iBee App according to an embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

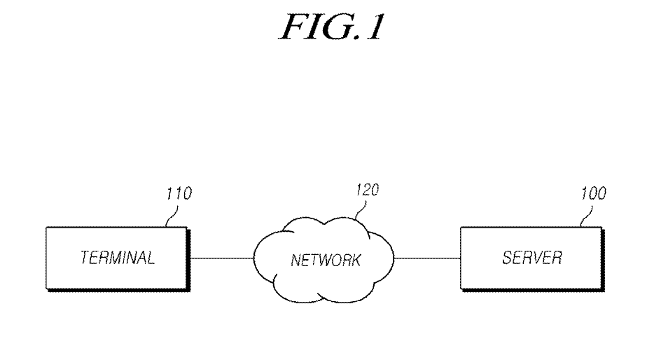

FIG. 1 illustrates a system for providing a mobile application according to an embodiment of the present invention.

Referring to FIG. 1, the system for providing a mobile application according to an embodiment of the present invention includes a server 100 adapted to provide a mobile application and a terminal 110 (terminal device) adapted to receive a mobile application from the server 100.

The server 100 may also be an application server adapted to perform control so that a mobile application can operate on the terminal 110. In this case, the terminal 110 can download a relevant program (application), in order to drive a mobile application, from the server 100, install the program, and execute the program so that the mobile application can be executed or played while communicating with the server 100. Alternatively, the terminal 110 can execute the application solely based on communication with the server 100, without downloading the mobile application relevant program from the server 100. In this case, the server 100 can provide the terminal 110 with displayable graphic information. It is also possible to provide a function for displaying the graphic information using the mobile application relevant program.

The server 100 can relay execution data regarding applications executed on a plurality of terminals 110, respectively, in real time so that application information can be shared among users; control the output of mobile application execution screens on the plurality of terminals 110, respectively; or perform synchronization regarding mobile application executions on the plurality of terminals 110, respectively.

The server 100 can also process the proceeding results of mobile applications, which are created and executed by a plurality of terminals 110 controlled by users, and provide the plurality of terminals 110, which are controlled by respective users, with the processing results.

The server 100 can be joined by a terminal 110 and then provide the joined terminal 110 with a page of a corresponding website. The server 100 can conduct a member enrollment procedure; store and manage various types of information regarding enrolled users (including user information); provide functions for purchasing and settling charges regarding various characters and items associated with a mobile application; and store and manage a list of owned characters and a list of owned items, etc., in conformity with the user information. A character, as used herein, can be interpreted as a type of item or an equivalent thereof.

The above-mentioned terminal 110 includes a conventional PC, such as a conventional desktop or a laptop, as well as a mobile terminal, such as a smart phone, a tablet PC, a PDA (Personal Digital Assistant), and a mobile communication terminal. However, the terminal 110 is not limited to these examples, but is to be interpreted in a broader sense as any electronic device capable of communicating with the server 100.

The above-mentioned server 100 has the same construction, in terms of hardware, as a conventional web server, a web application server, or a WAP server. However, in terms of software, the server 100 can include a program module implemented by various languages, such as C, C++, Java, PHP, .Net, Python, Ruby, to execute various functions.

The server 100 can be connected to a number of unspecified clients (including terminals 110) and/or a different server through the network 120. In this connection, the server 100 could refer to a computer system adapted to receive a task execution request of a client or a different server, extract a relevant task result, and provide it or computer software (server program) installed for such a computer system.

The server 100, besides the above-mentioned server program, is also be to understood in a broader sense to include a series of application programs operating on the server 100 and, if necessary, various databases constructed internally or externally.

The server 100 can also store contents and various types of information and data in the database and manage them. The database can be implemented inside or outside the server 100.

The server 100 can be implemented on conventional server hardware using a server program, which is variously provided based on the operating system, such as DOS, Windows, Linux, UNIX, Macintosh, and typical examples include Website and IIS (Internet information Server), which are used in Windows environments, and Apache, Nginx, and Light HTTP, which are used in UNIX environments.

The server 100 is adapted to enable application downloads so that, in the case of a terminal equipped with iOS or Android, the server 100 can be a device serving as App Store of iOS or Android Market of Android. The server 100 can be a device run by a developer, who provides a mobile application independently, or run by a developing company or a company selling a mobile application.

The network 120 is adapted to connect the server 100 and the terminal 110 and can be either a closed network, such as a LAN (Local Area Network) or a WAN (Wide Area Network), or an open network such as the Internet. As used herein, the Internet refers to a worldwide open computer network structure providing TCP/IP protocols and various services existing on their upper layers, i.e. HTTP (HyperText Transfer Protocol), Telnet, FTP (File Transfer Protocol), DNS (Domain Name System), SMTP (Simple Mail Transfer Protocol), SNMP (Simple Network Management Protocol), NFS (Network File Service), NIS (Network Information Service). The network 120 is not limited to wired/wireless networks, but can be coupled to various wireless network technologies, such as LTE (Long Term Evolution) and WiBro.

When the terminal 110 includes a mobile terminal, such as a smart phone, a tablet PC, a PDA, and a mobile communication terminal, the network 120 can further include a mobile communication network or a wireless access network, such as WiFi network.

The present invention seeks to market a mobile application, reward a user, who has marketed it, and implement such a rewarding mechanism on a server or a terminal.

More specifically, according to an embodiment of the present invention, a marketing platform is provided to distribute apps (applications, games, etc.), which can be executed on smart phones, tablets, etc., through buzz marketing (or word-of-mouth marketing), and participants of the platform include developers, marketers, and players.

The developers seek to distribute games using a marketing budget. The marketers execute mobile applications (e.g. games, apps) and post reviews or invite friends to create a buzz. The players install games based on reviews or invitations. According to the present invention, in order to promote marketing, a person is rewarded with cash depending upon the degree of the influence of his/her buzz. Specifically, individual marketers are rewarded with a part of a marketing budget (e.g. maximum of 70%, based on standards predetermined by the platform), which has been paid to the platform by a developer, and the platform claims the rest (e.g. 30%).

In other words, considering the characteristics of a mobile application, the present invention makes downloading and charge-settling convenient and provides a review after a download so that users can market the mobile application based on the provided review and get rewards based on the marketing results. According to an embodiment of the present invention, a developer pays the platform a predetermined amount of money (sometimes referred to herein as “a marketing campaign budget”, which is distributed between individual marketers and the platform based on player enrollment results, and a mobile device (e.g. smart phone, tablet) can be used throughout the entire payout process (discover, play, buzz, monetize).

Conventional mobile app marketing seeks to induce downloads by advertisements or directly reward a user who has installed an app. This type of marketing has a problem in that only installation for a reward occurs, but the rate of actual app use is very low. Therefore, the present invention does not reward for app installation, but for spreading the app, so that (1) net app users can be enrolled based on recommendations of acquaintances; (2) an individual marketer with stronger spreading influence is rewarded more; and (3) consequently, an app conforming to user preferences is matched through efforts of acquaintances (marketers).

Detailed embodiments for implementing this will now be described.

An exemplary reward server will now be described to implement a platform according to an embodiment of the present invention.

Data (information) stored or managed by the reward server will now be described.

The reward server is adapted to store download information used by mobile application developers to download applications developed by them.

The download information includes addresses used to download mobile applications. Assuming that a mobile application can be downloaded from App Store provided by Apple, the download information includes an address that enables access to a site within App Store, where the mobile application is available. Similarly, when a mobile application can be downloaded from Android Market provided by the Android platform, the download information includes an address that enables access to a site within Android Market, where the mobile application is available.

According to an embodiment of the present invention, assuming that a mobile application is stored in the reward server, the download information includes information enabling download of the mobile application in the corresponding reward server, such as the access address, application identification information, etc. Besides the information enabling download, the download information may include information regarding the developer or the developing company, information regarding descriptions of the mobile application to be downloaded, or identification information regarding the mobile application.

Marketing cost information concerns the amount of money paid by the mobile application developing company (developer) to the reward server to perform marketing. Therefore, the marketing cost information includes the total amount of money to be paid by the developer, the amount of money to be paid per each installation or per each mobile terminal, which installs a mobile application, when the mobile application is installed as a result of marketing, and, optionally, special reward money paid to a marketer, who induces the most mobile application installations.

Review information makes it possible to execute a mobile application and post a corresponding review, invite a friend, or publicize the review information through a SNS (Social Network Service), such as Twitter and Facebook. The review information includes i) identification information regarding a marketer engaged in marketing, ii) information regarding identification or download of a mobile application to be marketed, iii) review content, iv) information regarding recommendations of the review content, v) date at which the review was written, and vi) number of installations based on the review. The review information may additionally include information regarding interlinkage with the SNS. The review information may include the content of advertisement or marketing written by a user in connection with an app, i.e. detailed content of a buzz, and link metadata enabling viral marketing through the corresponding buzz.

Installation information concerns a case of checking out the review information and installing the mobile application. The installation information can include i) identification information for recognizing a mobile terminal that has installed the mobile application, ii) identification information regarding the marketer who has written the review information, and iii) identification information regarding the installed mobile application. The installation information may additionally include the installation date or, when a user has logged into the mobile terminal, information regarding the corresponding user.

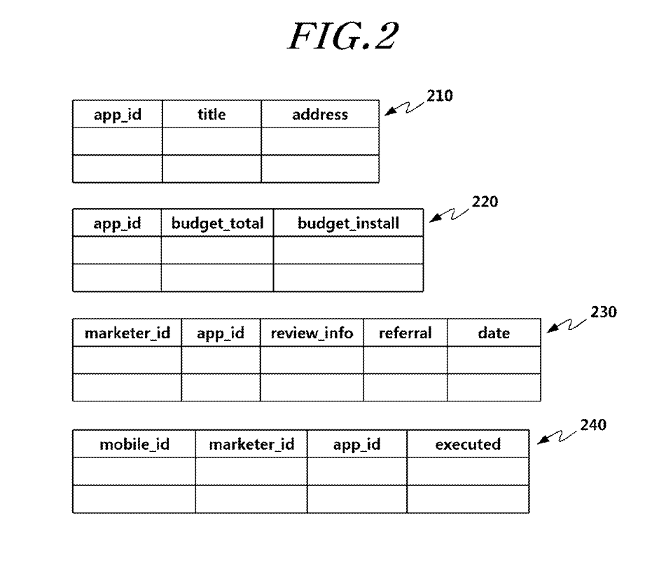

FIG. 2 illustrates the structure of pieces of information included in a database according to an embodiment of the present invention. The information illustrated in FIG. 2 is stored in the reward server, and detailed construction can be variously modified in connection with implementation or practice of the present invention.

Reference numeral 210 refers to an example of construction of a database for storing download information. Field “app_id” refers to identification information regarding a mobile application to be downloaded. Field “title” refers to the name of the mobile application. Field “address” refers to the address at which the mobile application can be downloaded, and can be address information enabling download within App Store, Android Market, or the reward server.

Reference numeral 220 refers to an example of construction of a database for storing marketing cost information. Field “app_id” refers to identification information regarding a mobile application to be downloaded and marketed. Field “budget_total” refers to an amount of money paid by the developing company/developer for marketing, and can be the total amount of money needed for marketing or the amount of money paid to individual marketers, save for the cost paid to the platform. Field “budget_install” refers to an amount of money paid to marketers based on mobile application installations, i.e. reward money.

Reference numeral 230 refers to an example of construction of a database for storing review information. Field “marketer_id” refers to information used to identify marketers, and field “app_id” refers to identification information regarding a mobile application, about which marketers write reviews for marketing. Field “review_info” refers to information regarding reviews written by marketers, and may be either review content or a URL address at which the review content is stored. The review content can include information indicating that a marketer has executed a game and increased the engagement level, etc. As will be explained later herein in more detail, the term “engagement level” means the degree of the marketer's expertise of the application. For example, if the application is a game that has a level or score which shows the progress of the gamer, then the “engagement level” can be a function of the level or score of that particular marketer. The type of review content is not limited to simple review writings, but also includes various contents such as information regarding screenshots showing applications executed by marketers, moving image information, etc.

Field “referral” refers to information regarding recommendations of reviews written by marketers. Reviews having more recommendations for a predetermined period of time can be provided in higher positions.

Field “date” refers to information regarding the point of time at which a review has been written. Fields “referral” and “date” can be included selectively.

Reference numeral 240 refers to an example of construction of a database for storing installation information, and includes information regarding the history of mobile applications installed as a result of marketing. Field “mobile_id” can be identification information regarding a mobile that has installed an application or the owner of the mobile; it can be the most basic mobile identification information, i.e. UDID; or it can be user information used by a platform provided according to an embodiment of the present invention. Field “marketer_id” refers to marketer identification information as in the case of reference numeral 230. Field “app_id” refers to identification information regarding a mobile application to be installed. Field “executed” refers to information regarding whether an installed mobile application has been executed or not.

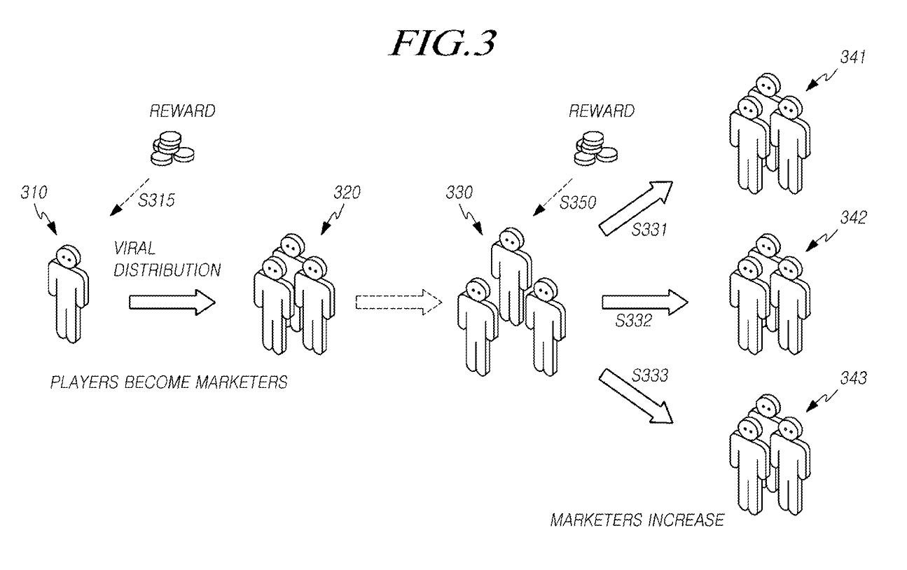

FIG. 3 illustrates a process of rewarding for mobile application marketing according to an embodiment of the present invention.

A player 310, i.e. a user who has installed and executed an application, performs a VD (Viral Distribution) task regarding the application installed by him/her. As used herein, the VD task refers to advertisement or introduction of the application, which is used by him/her, using a social network service such as Facebook, Twitter, and blogs. The VD process can be performed not only using a specific external SNS, but also using iBee App, which is an app that supports mobile application marketing proposed by the present invention. That is, iBee App can be used to implement the entire process of spreading viral marketing and checking it out. Furthermore, for the sake of rewarding when viral marketing is performed among users inside a network where marketing occurs (e.g. iBee network), a buddy importing or matching function can be provided using iBee App. In this process, screenshots of an application used by him/her, information enabling application download, or information regarding players who advertise the application can be included.

The screenshots can be used as information indicating that marketers have actually used the application, and this information can be variously distributed using an external SNS or iBee App.

When a number of players 320, who have received recommended application information from the player 310, install the corresponding application, the player 310, who has created the recommended application information, is provided with a predetermined reward (S315). The players 320 then can use each SNS to introduce or advertise the corresponding application as marketers 330 (S331, S332, S333). The marketers 330 then can be provided with a predetermined reward according to whether third players 341, 342, 343, who have contacted the marketers 330, install the application or not (S350).

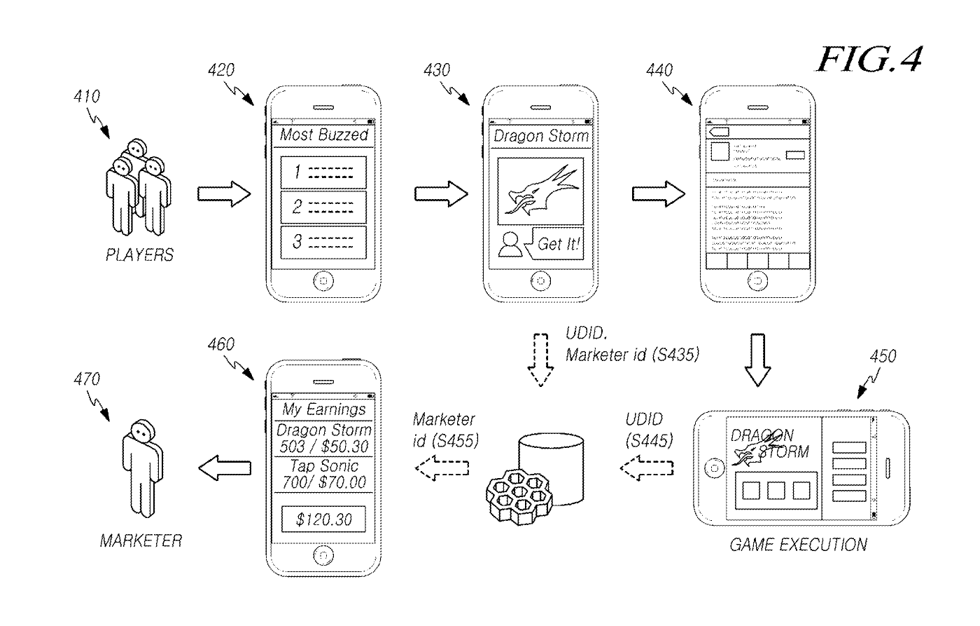

FIG. 4 illustrates a distribution scheme through app executing during a workflow for performing the VD task of FIG. 3. A VD app enabling a mobile-based VD task according to an embodiment of the present invention will be referred to as iBee App.

In FIG. 4, a number of players 410 execute iBee App program. As a result of execution, applications are sorted in such an order that the most introduced or recommended application comes first, as shown on the screen 420. A player selects a specific one from the recommendation writings (430) and installs a specific application included in the corresponding recommendation writing (440). When an introduction writing written by a specific marketer 470 is selected on the screen 430, the corresponding marketer's identification information (marketer id) and mobile identification information (UDID) of the player 410 are stored in the server (S435). When the game installed on the screen 440 is executed (450), the corresponding player's mobile terminal identification information (UDID) is transmitted to the server (S445). The marketer 470, who has consequently induced installation of the corresponding application, is provided with a reward (S455). The rewarding process is shown on the screen 460.

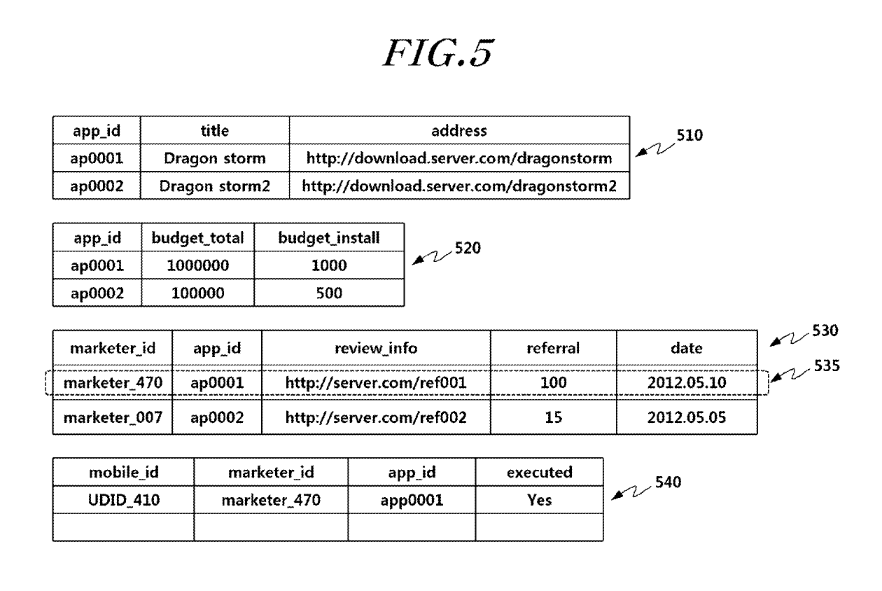

FIG. 5 illustrates application of information of the database shown in FIG. 2 to an embodiment of the present invention. Field 510 stores information regarding applications; field 520 stores information regarding budgets for marketing; and field 530 stores review information 535 created by marketers.

Information stored at field 530 is displayed on the screen 420 in FIG. 4. When the player 410 of FIG. 4 selects a review created by a marketer, whose identification information is ‘marketer_470’ on the screen 420, checks out review information on the screen 430 in FIG. 4, and selects the corresponding application (app_id=ap0001, title=“Dragon Storm”), information is stored in field 540. Specifically, field “mobile_id” stores information regarding the mobile terminal of a user who is about to install the application; field “marketer_id” stores identification information of marketer_470; and field “app_id” stores application identification information, i.e. ap0001.

Then, the game is executed as shown on the screen 450 in FIG. 4, and a reward is provided accordingly.

The reward is given based on the number of installations and executions. Information regarding whether execution is performed or not is stored on field 540 so that, by searching throughout the entire database 540 with a focus on “marketer_id”, it is possible to confirm which application has been installed and executed to what extent. This process can be implemented in such a manner that, for the same UDID, only one reward is given for installation of the same app.

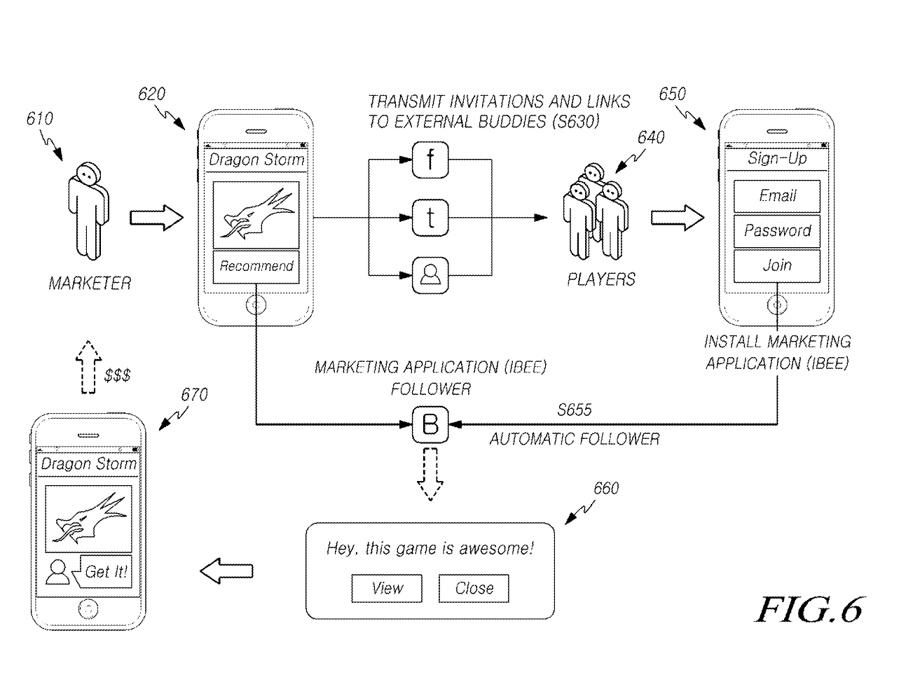

FIG. 6 illustrates a process of creating review information for a marketer to perform a VD task according to an embodiment of the present invention.

A marketer 610 creates review information regarding a specific application as shown on the screen 620. The created information is the same as stored on field 535 in FIG. 5. The page 620 can be composed using iBee App according to an embodiment of the present invention.

The created review information is spread to the outside using a social network (S630). The review information can also be spread, besides externally, inside a communication network using iBee App, i.e. used by a viral marketing application. The review page composed on the screen 620 is (S630) turned into, including links, writings of a specific SNS (writings of Facebook, tweets of Twitter, or other types of writings composed in other SNSs). Players 640 can check out the content of writings. The players 640 refer to users who maintain a buddy or follower relationship with the marketer in a number of SNSs, and the review information composed on the screen 620 can be displayed as a link within a SNS, or part/all of the reviewed content can be checked out. It is also possible to install iBee App within the mobile terminal (650), and, in this process, the players 640 can selectively create a buddy or follower relationship with the marketer 610 within the iBee App (S655). Information regarding the application reviewed on the screen 620 in this process is provided through a push notification (660), and the corresponding application can be installed (670).

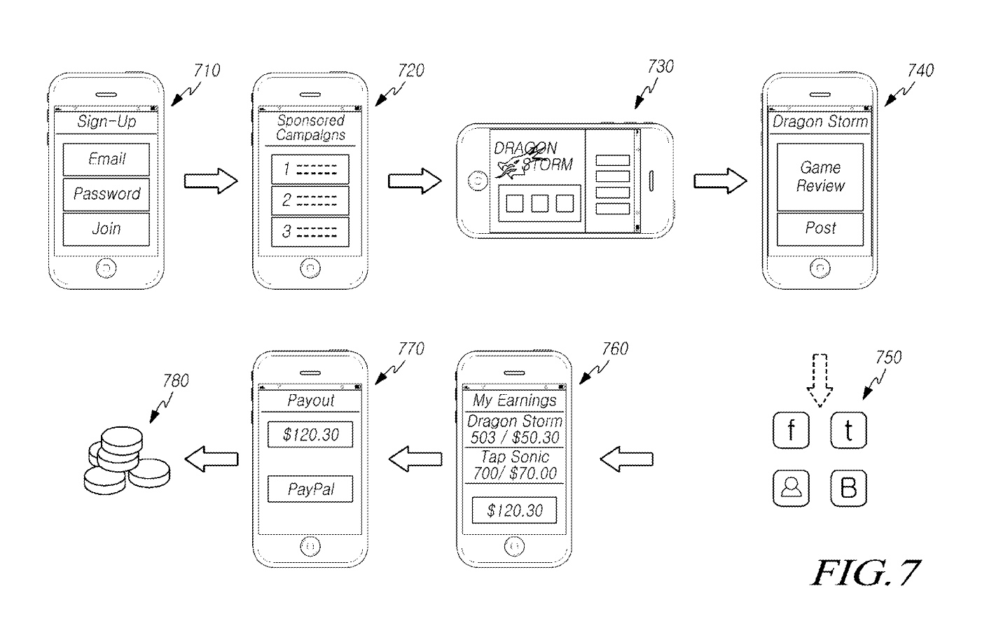

FIG. 7 illustrates a detailed example of writing a review according to an embodiment of the present invention. A VD app is installed, which enables a mobile-based VD task according to an embodiment of the present invention; the app is used to write a review; and the written review is distributed to various social networks (buzz, viral distribution). A reward for the performed VD task is acquired.

Firstly, a VD app (e.g. above-mentioned iBee App) is installed, and a sign-up and login process is performed (710). An application, which is a target of viral marketing, is selected and installed (720), and the corresponding app is executed (730). Recommendation/review information regarding the executed application is written (740). The written review is stored in the database as described with reference to FIG. 5. The written review information is spread/distributed using an external social network or a social network constructed by the VD app (750). When another player checks out the review information later and then installs the application, a reward is provided for each installed application (760). When a request is made that an actual reward be paid using an online payment system, such as PayPal (770), the money is transferred to an associated account or a virtual account (780).

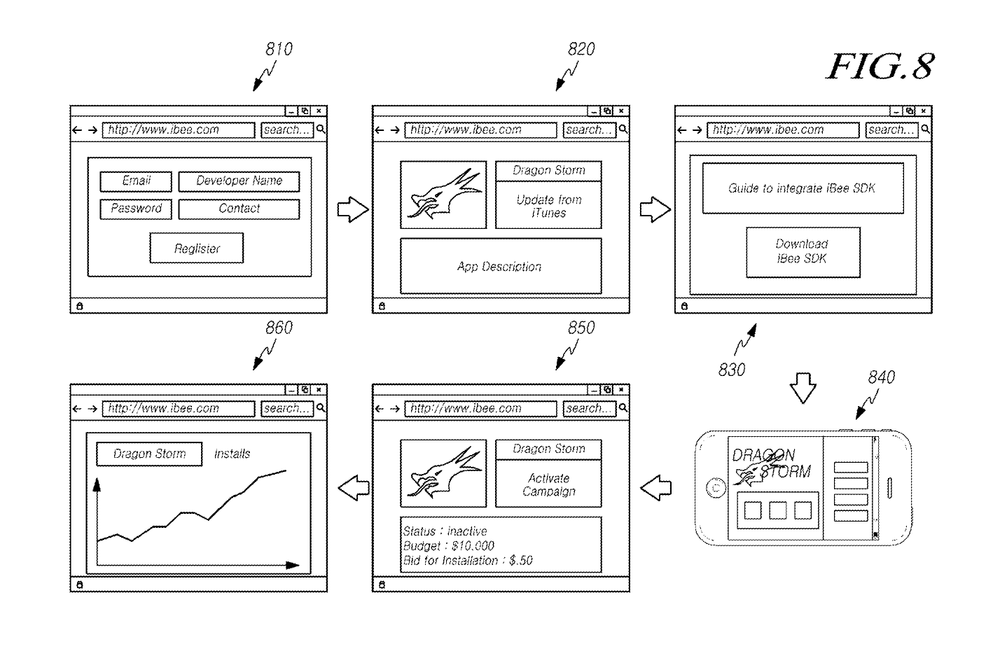

FIG. 8 illustrates a process of mobile-based promotion of a developed application by an application developing company or developer according to an embodiment of the present invention. Reference numeral 810 refers to a developer registration page, where developer information, passwords, etc. are entered. On the page 820, the developed application is uploaded to the server, or location information enabling download from an external app store is stored in the server. As used herein, the external app store refers to App Store provided by Apple or Android Market, which enables application installation on mobile terminals equipped with Android operating system; and the location information enabling download refers to a page within the external app store, from which the application can be installed (downloaded). Meanwhile, direct upload to the server is also possible. That is, when an application is registered on a server providing a VD function (e.g. ibee.com, which is a page of access by iBee App), a process 830 of coupling information requested by the corresponding server can be performed selectively. A SDK (Software Developer's Kit) can be downloaded in the process 830 and can be used for coupling to an application (840). Then, a marketing cost or budget is set and paid (850) by the developer to enable viral marketing of an application registered on the server or on the external app store. The marketing budget may also include the fee per installation that will be paid by the developer or developing company. Types of payment include use of a virtual account, bank account transfer, and Internet-based money transfer service (e.g. PayPal). The marketing cost is paid (850), and the marketing promotion process is checked out (860).

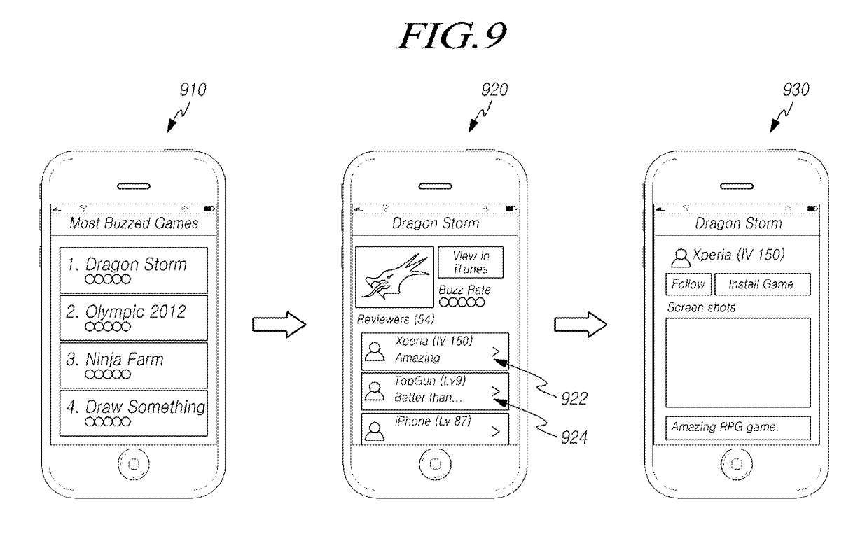

FIG. 9 illustrates a construction enabling differential rewarding based on competition between marketers according to an embodiment of the present invention.

In an embodiment of the present invention described above, reviews of marketers are sorted in the order of the number of recommendations or the time of update of reviews. In the embodiment illustrated in FIG. 9, the degree of reward is increased according to the level of execution of the corresponding application by marketers, or a higher position on the review page is assigned.

The system is configured in such a manner that, when many reviews are created for each application or for each marketer, reviews of a marketer, who provides players with good review information, are provided. FIG. 9 provides, as an exemplary application, a game.

Applications of the most viral distribution are displayed in order on the screen 910. An application of such viral distribution (buzz), as used herein, means that many users install the game and perform marketing. When a player clicks the top-ranked game (Dragon Storm), information regarding reviews of the corresponding game is displayed on the screen 920. In this case, the level (Lv) of game execution by the marketer, who has written the review, is displayed on the screen 920 together with the name of each marketer (922, 924). Respective grades (Amazing, Better than) of evaluation information of each marketer are displayed (922, 924). When a review 922 is clicked among the displayed reviews, the screenshot of the game played by the corresponding marketer (Xperia) is displayed together with corresponding game review information (930). When the game is installed/played after checking out the review, the marketer (Xperia) is rewarded.

When the scheme of FIG. 9 is applied, the marketer can not only publicize the game through an SNS, for example, but also play the game himself/herself and improve the engagement level to get more rewarding opportunities. More specifically, individual marketers create contents (game reviews, screenshots, game play moving images, etc.) that can induce game installation by players so that, when another player installs the game using the corresponding contents page, they are provided with a reward determined by the developer. Therefore, marketers can directly invite acquaintances to their contents pages and increase the engagement level to occupy higher positions on the review list. All of these activities, which aim at increasing the engagement level of the game, improve the reliability of information of the review system, multiply the effect of viral marketing, and make abusing of marketers difficult.

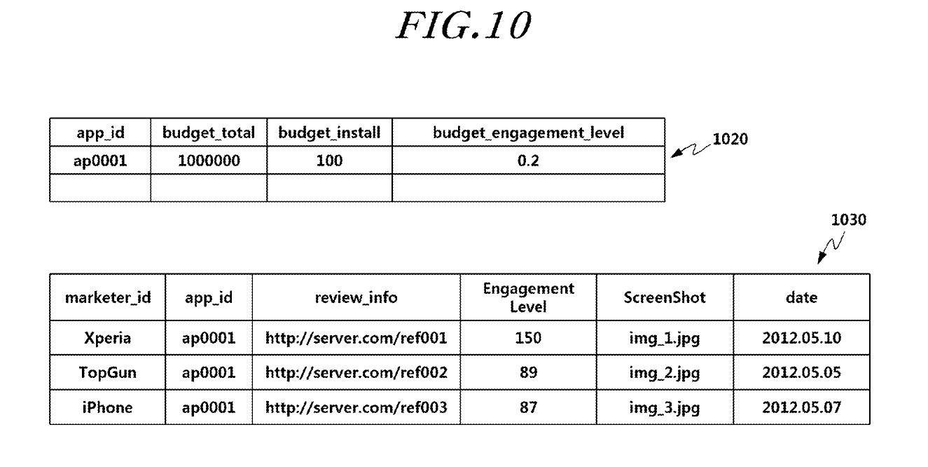

FIG. 10 illustrates a construction of a database for applying the scheme of FIG. 9.

The part “referral” of the construction of 230 in FIG. 2 is replaced with “Engagement Level”. Furthermore, information regarding screenshots during game play is required to be entered so that players are provided with more diversified game play screens.

In addition, the rewarding is not based on installation, but on the level so that the construction of 220 in FIG. 2 can be applied to FIG. 9.

In the field 1020, game identification information of “Dragon Storm” of FIG. 9 is ‘ap0001’; the total budget (budget_total) is ‘1000000’; the reward per installation (budget_install) is 100; and the engagement-based reward (budget_engagement_level) is 1. This means that, when a marketer engages in a game and writes a review and then a different player installs/plays the game based on the review, the marketer who wrote the review is additionally rewarded according to the game level at the time when the review was written or when the game was installed. Therefore, in the case of field 1020, ap0001 has 100 set for each installation and 0.2 for each level. In other words, when the level of the marketer included in the review of the marketer who wrote the review is 10, and when there exist players who installed the application based on the corresponding review, a total of 102 (100+0.2*10) is given as a reward.

Field 1030 stores information regarding the game level of each marketer. The game level can be updated in real time, but the game level at the time when the review is written can be entered, as in the case of FIG. 9. The app identification information of all of the three marketers (Xperia, TopGun, iPhone) displayed on the screen 920 in FIG. 9 is ‘ap0001’, reviews are written respectively, and the corresponding review page information is stored at field ‘review_info’. The game levels of the three marketers are given in field ‘Engagement Level’ as 150, 89, 87, respectively. Information regarding screenshot files captured during game play is included in field ‘ScreenShot’.

When a specific player installs and plays a game after reading a review of marketer ‘Xperia’ as shown in the screen 930 in FIG. 9, and when information given in fields 1020 and 1030 is applied, marketer ‘Xperia’ is given an installation-based reward (100) plus an engagement level-based reward (0.2*150, 30), thus a total of 130.

Those skilled in the art can understand that, without using the field ‘budget_engagement_level’ of the database 1020, a number of reviews can be listed in the order of engagement level as shown on the screen 920 in FIG. 9.

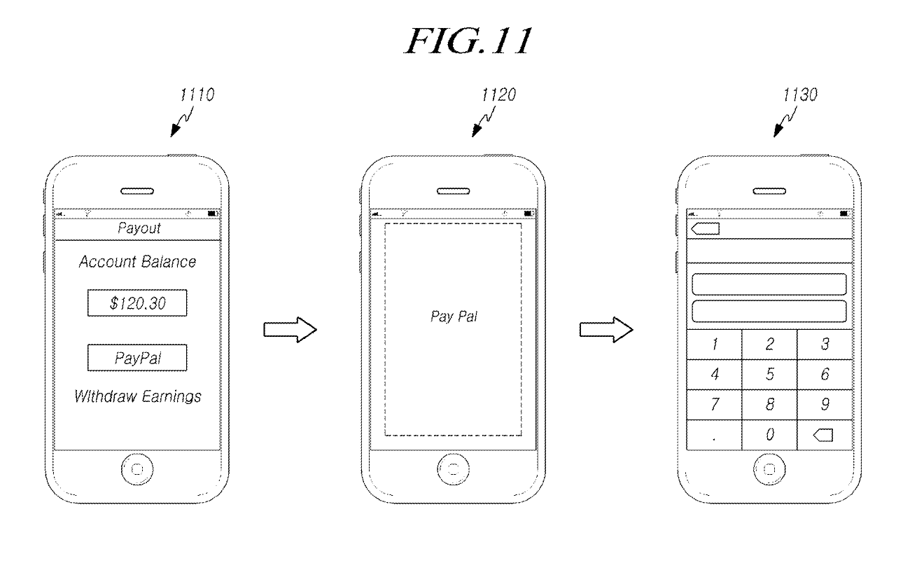

FIG. 11 illustrates a mobile cash transfer process using an online payment service according to an embodiment of the present invention. Particularly, FIG. 11 shows an example of directly transferring reward money, which has been accumulated through marketing activities, to a marketer's account using an online payment service (e.g. PayPal). This requires that the marketer sets his/her account information.

Reference numeral 1110 refers to a screen when a developing company or developer has logged into a specific online payment service to transfer money to a specific marketer. The reward cost is transferred using an API (Application Program Interface) provided by the online payment service as shown on the screen 1120. The money inside the online payment service is transferred to the bank account as shown on the screen 1130.

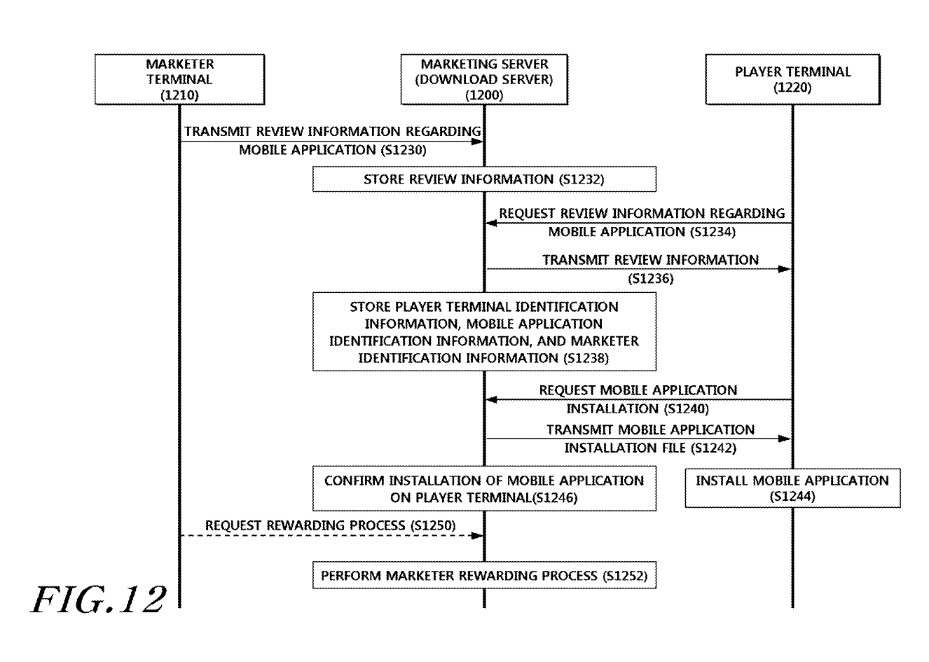

FIG. 12 illustrates a process according to an embodiment of the present invention. In FIG. 12, the marketing server is coupled or closely connected to a download server, which enables mobile application download, so that they are recognized as a single entity from outside the network. The term “closely connected” means that the relation of the marketing server and download server is close. For example, the marketing server and download server may be implemented in one computer, i.e. “closely connected”. Alternatively, the two servers can be implemented by separate computers connected together by a network.

The marketing server 1200 also acts as a download server. The marketer terminal 1210, which may be a terminal used by a marketer, is not a specified terminal, but any terminal used by the marketer after entering his/her ID/password and recognized by the marketing server. The player terminal 1220 is used to check out reviews about a mobile application and install the application based on the reviews. The mobile application does not require that a specific user log in, and the mobile terminal can be identified using the mobile terminal's own identification information (UDID, telephone number, etc.).

The marketer terminal 1210 transmits review information regarding a specific mobile application to the marketing server 1200 (S1230). The marketing server 1200 stores the review information (S1232). The review information can include, besides the review content written by the marketer, information regarding the engagement level, levels, items, or cyber money, which the marketer has obtained using the mobile application. The marketing server 1200 receives a message, which requires review information regarding the mobile application, from the player terminal 1220 (S1234). In this case, review information regarding a number of mobile applications can be requested. Alternatively, the player terminal 1220 is provided with at least two pieces of review information in a predetermined order; the player terminal 1220 selects one from them; and the selected review information is provided.

The marketing server 1220 transmits the review information (S1236) and, in order to record the fact that the review information has been transmitted to the player terminal, stores the player terminal's identification information, mobile application identification information, and identification information regarding the marketer who has written the review in the history database (S1238). This is used as materials based on which the marketer will be rewarded when the mobile application is installed later.

When the player terminal 1220 requests mobile application installation later (S1240), the marketing server 1220 transmits an installation file to the player terminal so that the mobile application can be installed (S1242). The installation file is either an actual file to be installed or external website information that induces installation. Considering the fact that the download server and the marketing server are implemented as an identical entity on the network in the case of FIG. 12, the installation file may be information not regarding an external website, but a website provided by the marketing server. The player terminal 1220 installs the mobile application (S1244). The marketing server 1220 confirms that the mobile application has been installed on the player terminal (S1246), and performs a marketer rewarding process (S1252). In this process, the marketer terminal 1210 can directly request the rewarding process (S1250); alternatively, the marketing server 1200 can perform the rewarding process in a batch mode at a predetermined time.

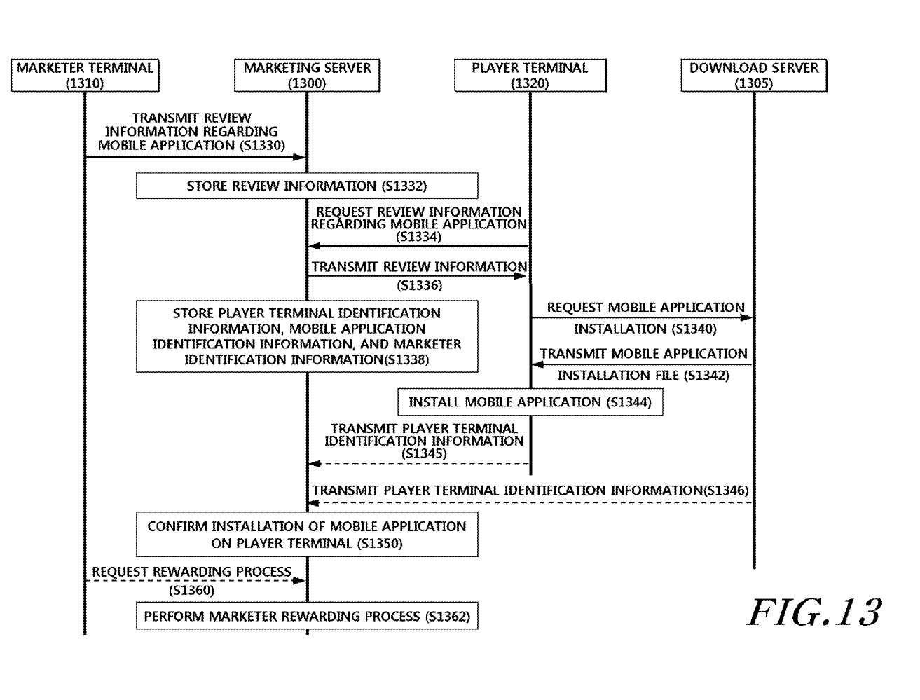

FIG. 13 illustrates a process according to another embodiment of the present invention. Unlike the case of FIG. 12, the marketing server is separate from the download server, which enables mobile application download, in the case of FIG. 13.

The marketer terminal 1310, which may be a terminal used by a marketer, is not a specified terminal, but any terminal used by the marketer after entering his/her ID/password and recognized by the marketing server. The player terminal 1320 is used to check out reviews about a mobile application and install the application based on the reviews. The mobile application does not require that a specific user log in, and the mobile terminal can be identified using the mobile terminal's own identification information (UDID, telephone number, etc.).

The download server 1305 is adapted to provide mobile terminals with an installation file so that the mobile application can be installed.

The marketer terminal 1310 transmits review information regarding a specific mobile application to the marketing server 1300 (S1330). The marketing server 1300 stores the review information (S1332). The review information can include, besides the review content written by the marketer, information regarding the engagement level, levels, items, or cyber money, which the marketer has obtained using the mobile application. The marketing server 1300 receives a message, which requires review information regarding the mobile application, from the player terminal 1320 (S1334). In this case, review information regarding a number of mobile applications can be requested. Alternatively, the player terminal 1320 is provided with at least two pieces of review information in a predetermined order; the player terminal 1320 selects one from them; and the selected review information is provided.

The marketing server 1320 transmits the review information (S1336) and, in order to record the fact that the review information has been transmitted to the player terminal, stores the player terminal's identification information, mobile application identification information, and identification information regarding the marketer who has written the review in the history database (S1338). This is used as materials based on which the marketer will be rewarded when the mobile application is installed later.

When the player terminal 1320 later accesses the download page of the download server 1305, which is included in the review, and requests mobile application installation (S1340), the download server 1305 transmits an installation file to the player terminal so that the mobile application can be installed (S1342). The installation file is either an actual file to be installed or external website information that induces installation. The player terminal 1320 installs the mobile application (S1344).

When the installation is completed, the player terminal 1320 can transmit the player terminal's identification information to the marketing server 1300 to inform of the mobile application installation (S1345). This can be implemented by the player terminal using a separate application provided by the marketing server, or a function included in the mobile application can be used, when the mobile application is installed, to inform the marketing server 1300 of the installation. As an alternative to step S1345, the download server 1305 can transmit, after the mobile application is installed, player terminal identification information to the marketing server 1300 (S1346). This is possible when the download server 1305 and the marketing server 1300 decide to exchange information regarding mobile application installation between them. Steps S1345 and S1346 can be implemented selectively.

The marketing server 1320 confirms that the mobile application has been installed on the player terminal (S1350), and performs a marketer rewarding process (S1362). In this process, the marketer terminal 1310 can directly request the rewarding process (S1360); alternatively, the marketing server 1300 can perform the rewarding process in a batch mode at a predetermined time.

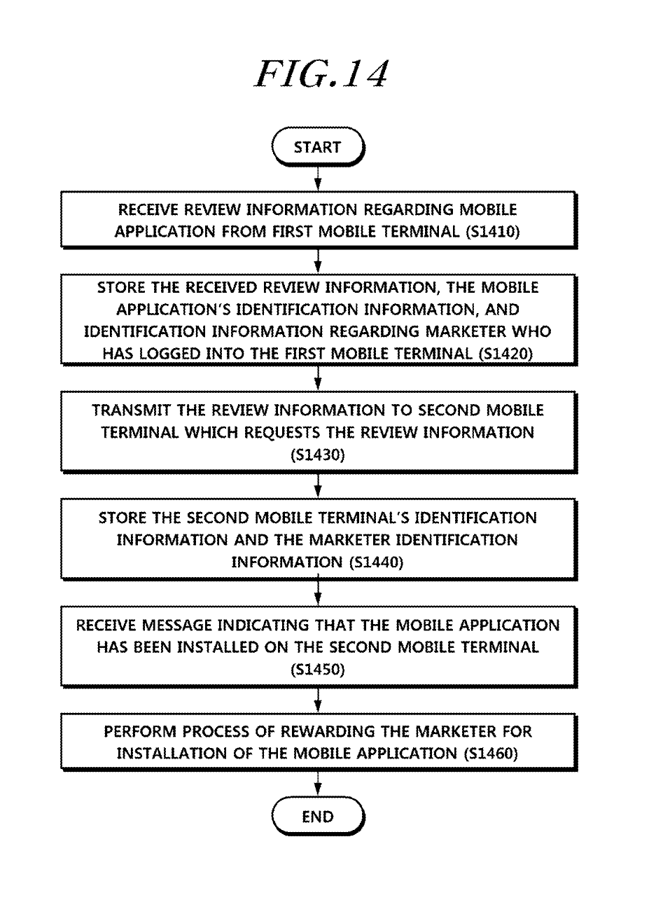

FIG. 14 illustrates a detailed process of rewarding for mobile application marketing by a marketing server according to an embodiment of the present invention.

The marketing server receives review information regarding a mobile application from a first mobile terminal (S1410). The marketing server stores the received review information, the mobile application's identification information, and identification information regarding the marketer who has logged into the first mobile terminal (S1420). The marketing server transmits the review information to a second mobile terminal, which requests the review information (S1430). The second mobile terminal includes the player terminal described with reference to FIGS. 12 and 13.

The marketing server stores the second mobile terminal's identification information and the marketer identification information (S1440). The history information 240 (FIG. 2) or 540 (FIG. 5) is also stored.

The marketing server receives a message indicating that the mobile application has been installed on the second mobile terminal (S1450). More specifically, according to whether the download server is closely connected to the marketing server so that they are recognized as an identical identity from the outside (FIG. 12) or the marketing server and the download server have different constructions (FIG. 13), the message is received from the second mobile terminal or from the download server, or the marketing server makes its own decision and receives a message from the download process. The marketing sever then performs a process of rewarding the marketer for the mobile application installation (S1460).

To be more specific, the process of transmitting the review information to the second mobile terminal can include the processes of 1) transmitting at least two pieces of identification information regarding at least two pieces of review information regarding the mobile application, 2) receiving one of the at least two pieces of identification information regarding at least two pieces of review information from the second mobile terminal, and 3) transmitting review information, which corresponds to the received identification information, to the second mobile terminal. These processes are implemented in the following manner: when at least two reviews exist regarding a mobile application, identification information regarding these reviews and brief information about them (marketer identification information or a part of review content, etc.) are initially transmitted to the second mobile terminal; the second mobile terminal selects specific review information and requests identification information regarding the corresponding review information; and identification information regarding the selected review information is provided.

In the process of transmitting at least two pieces of identification information regarding at least two pieces of review information, the marketer's application engagement level can be reflected.

For example, the at least two pieces of identification information regarding at least two pieces of review information can be sorted in such an order that review information written by a marketer of a high mobile application engagement level comes first, and then transmitted. The engagement level can be variously determined depending on the type of application.

For example, when the mobile application is a game application, the engagement level can be one selected from a level which the marketer has obtained by executing the game application, a game item, and game money. Besides these, it is also possible to use a game achievement which the marketer has accomplished by executing the game application: examples of the engagement level include the number of other game players joining a guild built by the marketer and the game execution time.

Besides game applications, various mobile applications can incorporate various functions for determining the engagement level. In the case of a document composition application, for example, the fact that the application has been executed at least K times, or a document composed by the application has been transmitted via mail at least N times can be considered.

To this end, a specific function and a condition to be a marketer can be added during the mobile application fabrication process, and a function for separately counting the engagement level can be embedded in the application.

Such a mobile application engagement level of a marketer can be used to assign priority in the process of providing reviews, or to give a bonus in the marketer rewarding process.

Specifically, as described with reference to FIG. 10, in the case of a game application, a weight can be assigned to the level, game item or game money in the process of rewarding the marketer.

Besides game applications, a weight can be assigned, in the case of a mobile application, to a specific function, the degree of accumulation of use time, degree of concentration of time of use of the mobile application for a predetermined period of time, or point/level/item/cyber money acquired by using the application so that a bonus can be provided in the process of rewarding a marketer of a high engagement level.

This can induce improvement of the mobile application engagement level of the marketer. Meanwhile, in order to be able to predict the marketing cost or budget of the application developing company/developer, the upper limit of bonus can be determined.

In the process of transmitting at least two pieces of identification information regarding at least two pieces of review information, the number of recommendations by other users regarding the marketer's review information can be reflected.

Specifically, the at least two pieces of identification information regarding at least two pieces of review information can be sorted in such an order that review information having the highest number of recommendations regarding it comes first, and then transmitted. This can be performed in the following manner: all users who check out the review information make recommendations; or the review information is checked out, the application is installed, and then recommendations are made. In addition, considering the fact that, when it comes to the recommendation number, a person who has posted a review first may have an advantage, both the number of accumulated recommendations and the number of recommendations for a predetermined period of time can be considered for sorting, or only the number of recommendations for a predetermined period of time can be considered for sorting.

In the above-mentioned case of applying the application engagement level to sorting of review information, a person who has first installed and executed a mobile application may also have an advantage. Therefore, both the accumulated engagement level and the engagement level for a predetermined period of time can be considered for sorting, or only the engagement level for a predetermined period of time can be considered for sorting.

When the second mobile terminal has checked out at least two pieces of review information regarding a specific mobile application and then installs the application, the marketing server can reward for review information checked out when the application is installed, or for review information recommended or selected by the second mobile terminal.

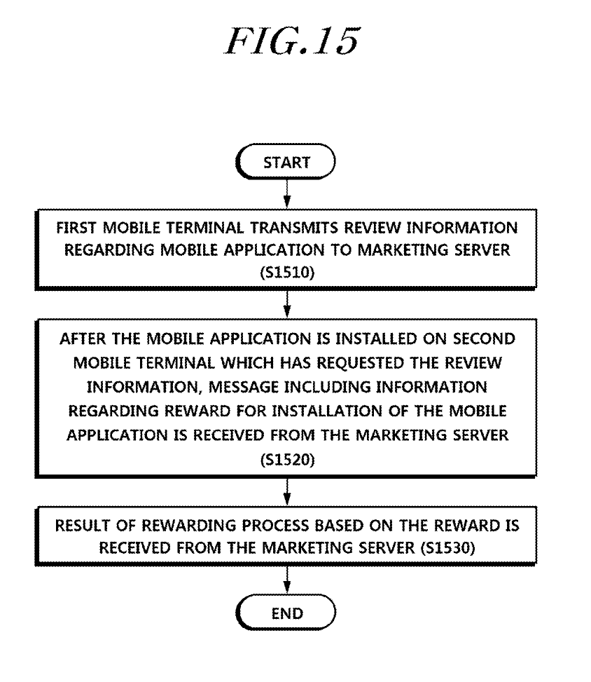

FIG. 15 illustrates a process of performing mobile application marketing on a mobile terminal used by a marketer according to an embodiment of the present invention.

The first mobile terminal transmits review information regarding a mobile application to the marketing server (S1510).

After the mobile application is installed on the second mobile terminal, which has requested the review information, the first mobile terminal receives a message, which includes information regarding a reward for installation of the mobile application, from the marketing server (S1520). The first mobile terminal receives a result of performing a rewarding process, based on the reward, from the marketing server (S1530).

The message including reward information can be selectively set by the marketer. Furthermore, as mentioned above, the review regarding the mobile application written by the marketer can be transmitted to the second mobile terminal together with review information regarding the mobile application written by another marketer. In addition, the review information may be one of at least two reviews regarding the mobile application, which is written by a marketer having a high mobile application engagement level.

As mentioned above, the marketer can, when writing a review, include information regarding the engagement level in the review. For example, when the mobile application is a game application, one selected from a level, a game item, and game money, which the marketer has acquired by executing the game application, can be included in the review information as the engagement level.

Furthermore, in the rewarding process, a weight can be assigned to the level, game item, or game money to reward the marketer. This is the same as in the case of the rewarding process based on the application engagement level, which has been described with reference to FIGS. 9-14.

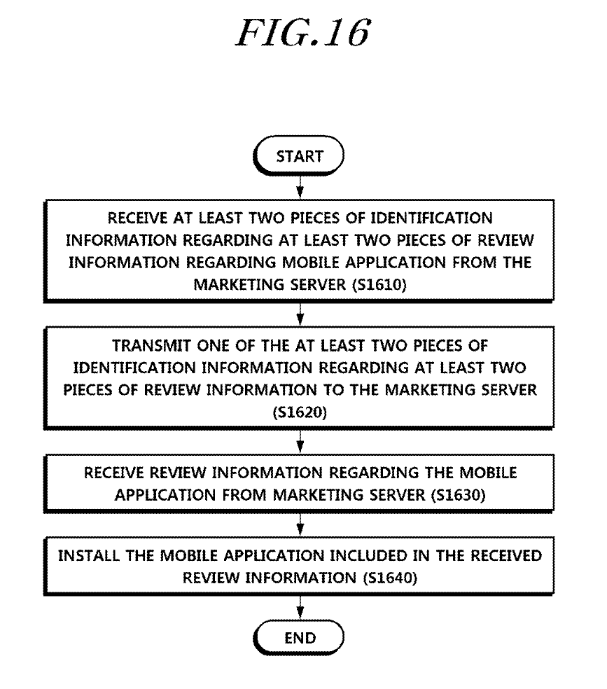

FIG. 16 illustrates a process implemented on a mobile terminal, which checks out a review of a mobile application and installs the mobile application according to an embodiment of the present invention.

The mobile terminal receives at least two pieces of identification information regarding at least two pieces of review information regarding a mobile application from the marketing server (S1610). The mobile terminal selects one from the at least two pieces of identification information regarding at least two pieces of review information, transmits the selected identification information regarding review information to the marketing server (S1620), and receives the selected review information regarding a mobile application from the marketing server (S1630).

To be more specific, the process of receiving the review information by the mobile terminal can include the processes of 1) receiving at least two pieces of identification information regarding at least two pieces of review information regarding the mobile application, 2) selecting one from the at least two pieces of identification information regarding at least two pieces of review information and transmitting the selected identification information to the marketing server, and 3) receiving review information, which corresponds to the transmitted identification information, from the marketing server. These processes are implemented in the following manner: when at least two reviews exist regarding a mobile application, identification information regarding these reviews and brief information about them (marketer identification information or a part of review content, etc.) are first received; specific review information is selected, and identification information regarding the corresponding review information is requested; and identification information regarding the selected review information is received.

The at least two pieces of identification information regarding at least two pieces of review information, which are received from the marketing server, can be sorted based on the marketer's application engagement level.

For example, the at least two pieces of identification information regarding at least two pieces of review information can be sorted in such an order that review information written by a marketer of a high mobile application engagement level comes first, and then received. The engagement level can be variously configured depending on the type of application.

For example, when the mobile application is a game application, the engagement level can be one selected from a level, a game item, and game money, which the marketer has obtained by executing the game application. Besides these, it is also possible to use a game achievement which the marketer has accomplished by executing the game application: an example of the engagement level is the number of other game players joining a guild built by the marketer; and the game play time can be reflected as the engagement level for sorting.

In the process of receiving at least two pieces of identification information regarding at least two pieces of review information, the number of recommendations by other users regarding the marketer's review information can be reflected.

Specifically, the at least two pieces of identification information regarding at least two pieces of review information can be sorted in such an order that review information having the highest number of recommendations regarding it comes first, and then received. This can be performed in the following manner: all users who check out the review information make recommendations; or the review information is checked out, the application is installed, and then recommendations are made. In addition, considering the fact that, when it comes to the recommendation number, a person who has posted a review first may have an advantage, both the number of accumulated recommendations and the number of recommendations for a predetermined period of time can be considered for sorting, or only the number of recommendations for a predetermined period of time can be considered for sorting.

In the above-mentioned case of applying the application engagement level to sorting of review information, a person who has first installed and executed a mobile application may also have an advantage. Therefore, both the accumulated engagement level and the engagement level for a predetermined period of time can be considered for sorting, or only the engagement level for a predetermined period of time can be considered for sorting.

Then, the mobile terminal installs the mobile application included in the received review information (S1640).

The mobile terminal, after installing the mobile application at step S1640, can make a recommendation or, as in the case of FIG. 13, inform the marketing server of installation of the mobile application.

When the second mobile terminal has checked out at least two pieces of review information regarding a specific mobile application and then installs the application, the marketing server can reward for review information checked out when the application is installed, or for review information recommended or selected by the second mobile terminal.

After the application is installed on the mobile terminal, the marketing server performs a process of rewarding the marketer, who has written the corresponding review, for installation of the mobile application.

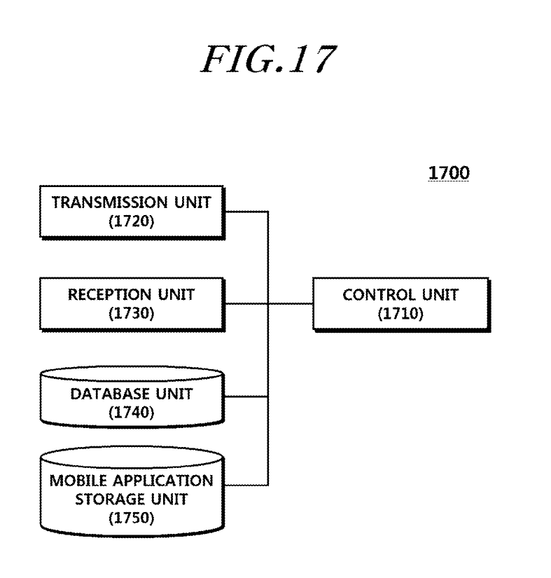

FIG. 17 illustrates the construction of a marketing server adapted to reward for mobile application marketing according to an embodiment of the present invention.

The marketing server 1700 includes a control unit 1710, a transmission unit 1720, a reception unit 1730, and a database unit 1740. The marketing server is adapted to perform the above-mentioned mobile application marketing, more specifically implement the embodiment shown in FIGS. 2-14.

The reception unit 1730 is adapted to receive review information regarding a mobile application from a first mobile terminal. The database unit 1740 is adapted to store the received review information, the mobile application's identification information, and identification information regarding a marketer who has logged into the first mobile terminal. The transmission unit 1720 is adapted to retrieve the review information from the database unit 1740 and transmit the retrieved review information to a second mobile terminal, which requests the review information.

The control unit 1710 is adapted to perform, when the reception unit 1730 receives a message indicating that the mobile application has been installed on the second mobile terminal, a process of rewarding the marketer for installation of the mobile application.

The database unit 1740 is adapted to arrange and store various types of information.

When the marketing server is identical to the download server as in the case of FIG. 12, a mobile application storage unit 1750 stores the mobile application.

Detailed processes performed by the marketing server 1700 of FIG. 17 implement the process described with reference to FIGS. 12-14, and repeated descriptions thereof will be omitted herein.

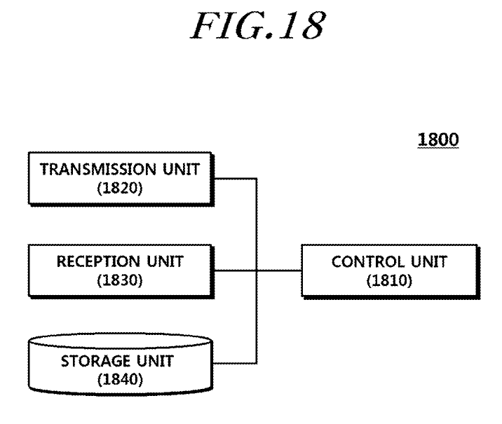

FIG. 18 illustrates the construction of a mobile terminal in connection with mobile application marketing according to an embodiment of the present invention.

The terminal of FIG. 18 can be a terminal used by a marketer or a terminal used by a player who wants to install a mobile application. The mobile terminal 1800 includes a control unit 1810, a transmission unit 1820, a reception unit 1830, and a storage unit 1840.

The terminal will now be described in connection with its use by a marketer.

The transmission unit 1820 is adapted to transmit review information regarding a mobile application to a marketing server. The reception unit 1830 is adapted to receive, after the mobile application is installed on a second mobile terminal which has requested the review information, a message including information regarding a reward for installation of the mobile application from the marketing server. The control unit 1810 is adapted to control the transmission unit 1820, the reception unit 1830, and the storage unit 1840. The control unit 1810 is also adapted to control the reception unit 1830 so as to receive a result of performing a rewarding process, based on the reward, from the marketing server.

As described with reference to FIGS. 9-11, in order for the marketer to include the application engagement level in the review information, the mobile application needs to be stored in the terminal. In this connection, the storage unit 1840 stores such a mobile application.

Detailed processes performed by the mobile terminal 1800 used by the marketer of FIG. 18 implement the process described with reference to FIGS. 12, 13, and 15, and repeated descriptions thereof will be omitted herein.

The terminal will now be described in connection with its use by a player.

The control unit 1810 is adapted to control the transmission unit 1820, the reception unit 1830, and the storage unit 1840.

The reception unit 1830 is adapted to receive at least two pieces of identification information regarding at least two pieces of review information regarding a mobile application from the marketing server. The transmission unit 1820 is adapted to transmit one of the at least two pieces of identification information regarding at least two pieces of review information to the marketing server. When the reception unit 1830 receives review information regarding the mobile application from the marketing server, the control unit 1810 controls so as to install the mobile application included in the received review information. The mobile application is stored in the storage unit 1840 and installed. The marketing server performs a process of rewarding the marketer, who has written the review, for installation of the mobile application.

As described with reference to FIGS. 9-11, review information reflecting the application engagement level can be received, and it is possible to select one from multiple pieces of review information, through the control unit 1810, and request the marketing server to provide it.

Detailed processes performed by the mobile terminal 1800 used by the marketer of FIG. 18 implement the process described with reference to FIGS. 12, 13, and 16, and repeated descriptions thereof will be omitted herein.

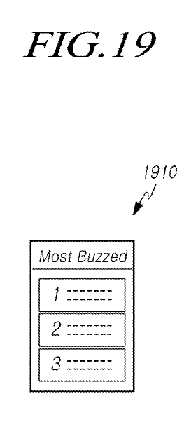

FIG. 19 illustrates a screen structure of a mobile terminal, on which a marketing application is installed, according to an embodiment of the present invention.

As described above, when a marketing application (e.g. iBee App) is installed, review information regarding a mobile application is provided as shown on the screen 1910. In this case, review information regarding a number of mobile applications can be variously sorted and provided.

Firstly, review information can be displayed in such an order that the most recently uploaded one comes first. This is based on the time at which review information is written.

Next, review information can be displayed in such an order that the most recommended one comes first. This is based on the number of recommendations of review information, and the number of recommendations accumulated for a predetermined period of time can be used as a reference for sorting.

Furthermore, review information can be displayed based on the engagement level of the marketer who wrote the review. This means that how vigorously or efficiently the marketer has used the corresponding application at the time of writing the review is reflected. As described above, in the case of a game application, a game level, an acquired item, or cyber money can be considered; and, in the case of a mobile application, use time or accumulated use time for a predetermined period of time can be considered. It is also possible to sort review information based on mobile packets transmitted/received during use. It can also be considered to assign a bonus (weight) to such information during rewarding, when the application is installed based on review information of the marketer.

The marketing application, as shown on the screen 1910, can also provide a function, when a marketer is connected to an external SNS and writes review information, to transmit the review to the external SNS. For example, the review information is posted on Facebook, Twitter, or blogs so that visitors or followers of Facebook/Twitter/blogs can check out the corresponding review information. In this process, in order to induce installation of the marketing application, a page for download of the marketing application can be included so that the review information is checked out in detail, and the application is then installed.

The marketing application can also provide a function for monitoring whether the application is installed on a player terminal or not and transmitting the monitoring result to the server as marketing base materials.

It is also possible to provide a section such as “Featured”, besides those shown on the screen 1910, to arrange and provide applications according to categories, number of recommendations, upload time, visitors' preferences, number of downloads or any custom criteria predetermined by the network operator. This enables the network operator, who operates iBee App, to sort applications according to a specific standard so that users can download them easily. Real-time rolling occurs, when “Featured” section is used, meaning that users who visit at a specific time can solely access it. Users can check out an app on “Featured” section, install the app, and spread it to other users to generate individual earnings (referral earnings).

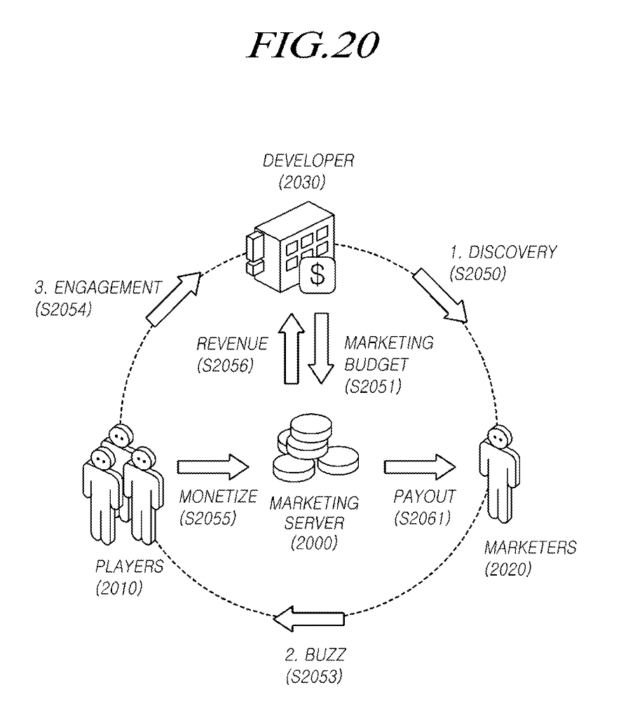

FIG. 20 illustrates a marketing rewarding process according to an embodiment of the present invention.

The application developer 2030 provides a marketing server operator with a marketing budget (S2051) and uses the marketing server 2000 to induce discovery of the application (S2052). The marketer checks out a mobile application directly/indirectly through the marketing server, installs the application, writes a review, and distributes it, i.e. performs buzz marketing (S2053). The player 2010, after checking out the distributed review, installs the corresponding application to engage with it (S2054) and, in this process, provides the marketing server with an application purchase cost (monetize)(S2055). The marketing server provides the developer 2030 with the cost of application installation paid by the player. When the marketing server 2000 is separate from the download server, steps S2055 and S2056 can be implemented independent of the marketing server.

The marketing server 2000 performs marketing rewarding (payout) for application installation, that installation is completed by the player 2010 who observed the review and installed the application.

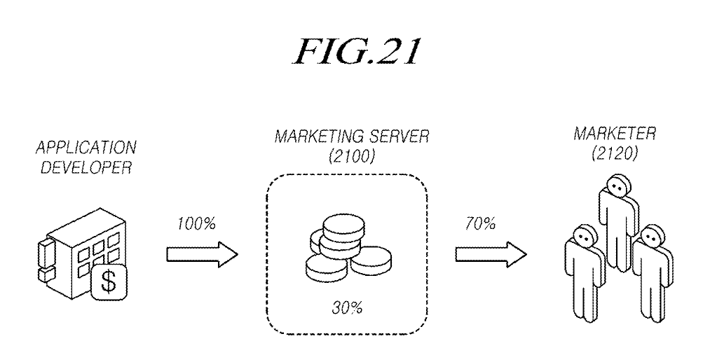

FIG. 21 illustrates a process of paying out rewards (e.g., money) in a marketing budget according to an embodiment of the present invention. The application developing company 2130 deposits 100% of the marketing budget in the marketing server 2100. The marketing server 2100 provides the marketers 2120 with money from the budget, which is the actual marketing cost, and its proportion to the marketing budget varies depending on the mode of implementation. The marketing server 2100 suspends marketing when the marketing budget is depleted. To this end, a function can be implemented in such a manner that, among pieces of review information, review information regarding an application, the marketing budget of which has been depleted, is no longer provided to players. That is, information regarding the balance of the marketing budget is always monitored to solely provide review information regarding an application with a positive balance.

According to an embodiment of the present invention, a number of users are enabled to play the role of both users, who install applications, and marketers, who market the applications, through iBee App and a network accessed by the iBee App. An implementation of iBee App according to an embodiment of the present invention, as well as an example of implementing the present invention, will now be described.

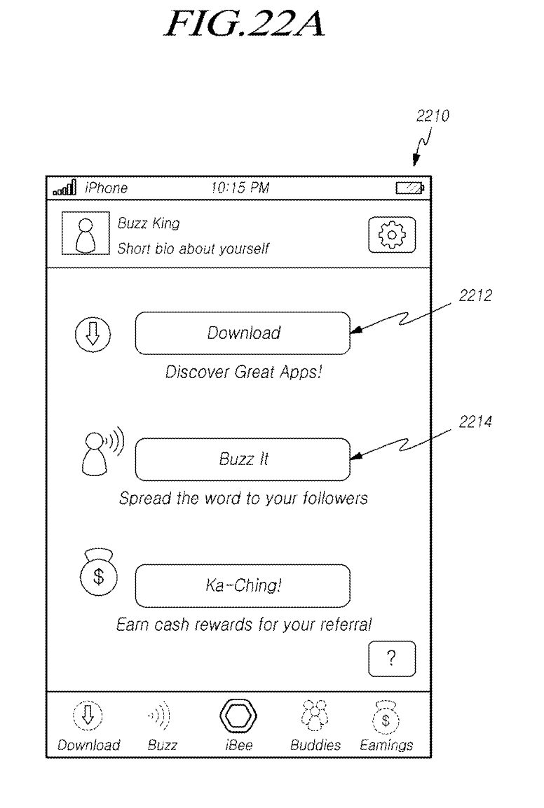

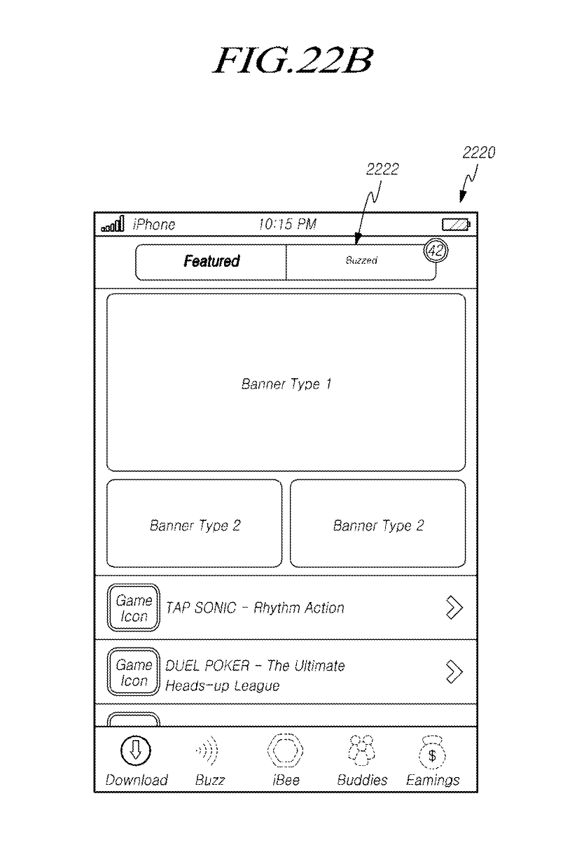

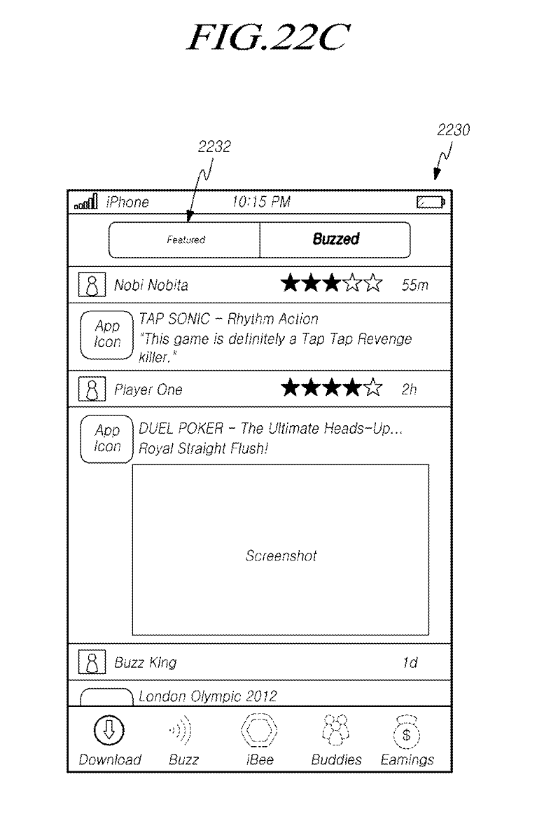

FIGS. 22A, 22B, and 22C illustrate a screen after installation of iBee App on a mobile terminal and following login according to an embodiment of the present invention.

The screen 2210 of FIG. 22A shows a user, who has logged in using ID ‘Buzz king’, and includes a button 2212 enabling application download and a button 2214 for marketing of a specific application. As used herein, the button refers to an interface, and clicking or pressing a button corresponds to switching to a new screen providing a new function. Hereinafter, pressing a button means selecting an interface, which is displayed as a button or a link, with a finger, a touch pen, or mouse click, and this includes all interface functions applicable to a conventional mobile terminal.

When the button 2212 is pressed, the screen 2220 of FIG. 22B or 2230 of FIG. 22C appears. When the screen 2220 appears first, it switches to the screen 2230 when the button 2222 is pressed; when the screen 2230 appears first, it switches to the screen 2220 when the button 2232 is pressed.

On the screen 2220 of FIG. 22B, “Featured” apps are displayed. This page is provided by iBee network, which is accessed by iBee App, based on a predetermined standard so that applications are rolled in real time or sorted based on a specific standard (e.g. category, download, recommendation number) and displayed. On the screen 2230 of FIG. 22C, the most “buzzed” application, e.g. an application that has been marketed the most for a predetermined period of time, is displayed; and, in this process, review information provided by a marketer, who has a large number of recommendations or downloads, can be selected and provided.

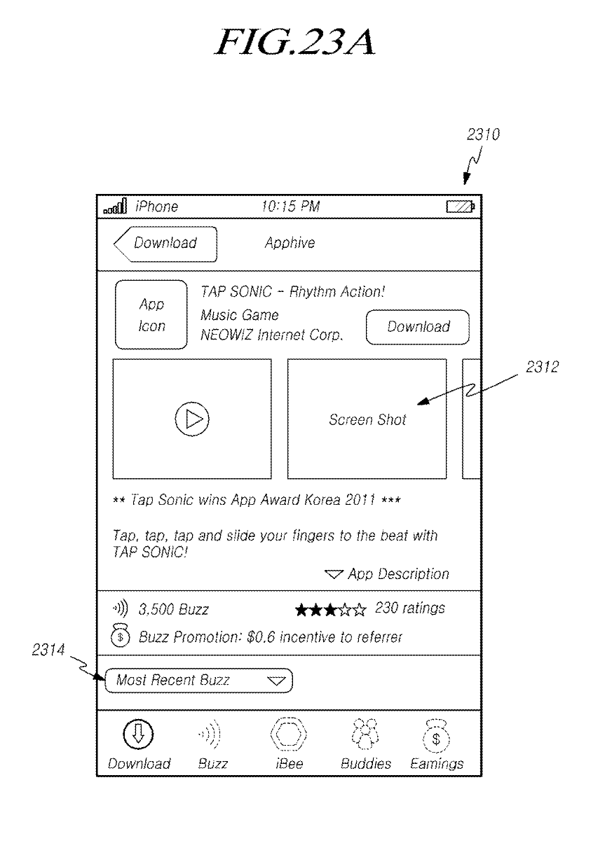

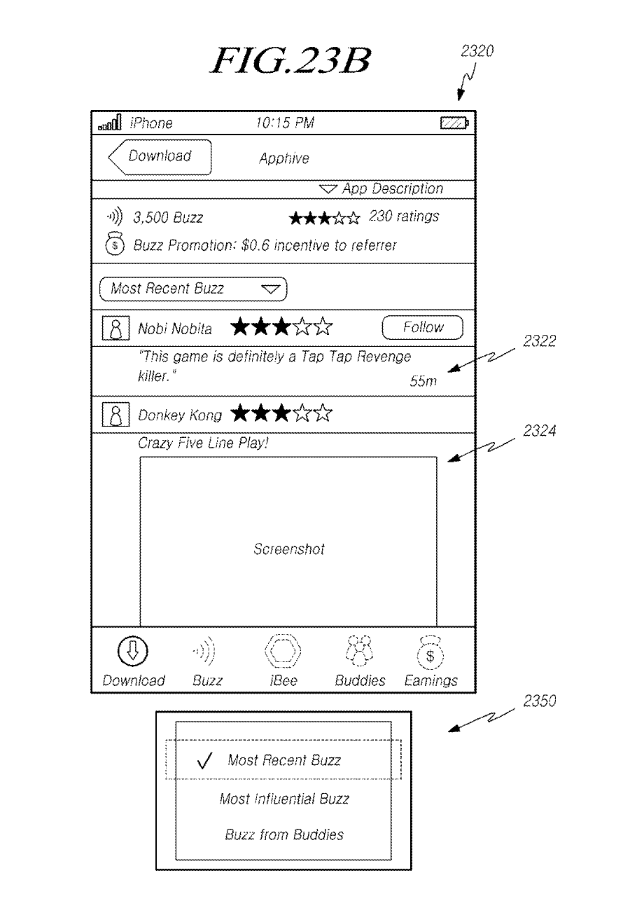

FIGS. 23A and 23B illustrate a process of downloading a specific application using iBee App according to an embodiment of the present invention.

On the screen 2310 of FIG. 23A, a specific application is displayed, and information regarding the application, screenshots 2312, etc. are provided.

When the button 2314 is selected, information regarding the corresponding application (buzz) 2322, which has been posted by the marketer most recently, can be checked out on the screen 2320 of FIG. 23B. When a number of marketers exist, multiple pieces of buzzed information can be sorted in such an order that the latest one comes first (2322, 2324).

Meanwhile, buzzed information can be sorted variously: it is possible to select from “Most Recent Buzz”, “Most Influential Buzz”, and “Buzz from Buddies”, as shown on the screen 2350. The “Most Influential Buzz” refers to information which has the largest recommendation number, or which has been selected by the largest number of people during download. The “Buzz from Buddies” refers to information created by a user, who is in a buddy relationship on iBee network. Besides these, various standards for providing information can be provided and can be listed on the screen 2350.

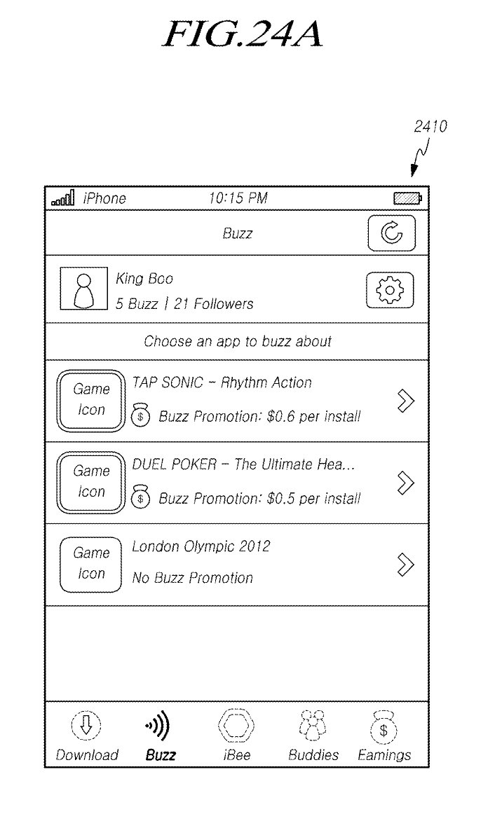

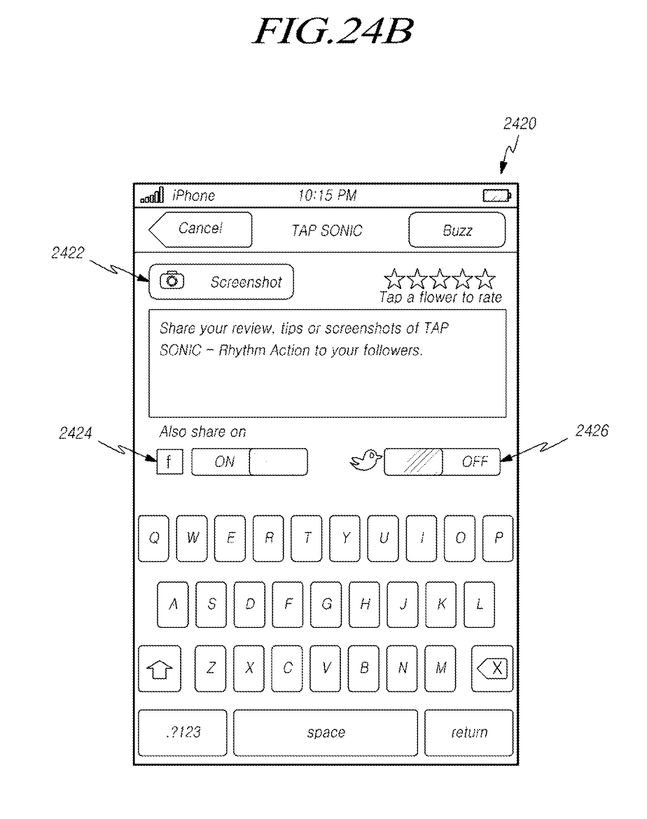

FIGS. 24A and 24B illustrate a process of marketing an application using iBee App according to an embodiment of the present invention.

The screen 2410 of FIG. 24A shows applications downloaded by the user. The title of each application and the amount of money provided in return for marketing (“Buzz Promotion”) are displayed. When an application to be marketed is selected, the screen 2410 switches to the screen 2420 of FIG. 24B where an interface is provided to create marketing review information. The button 2422 is used to execute a function for storing a screenshot of the corresponding application, taking an image of it, or capturing it. The buttons 2424 and 2426 are used to transmit review information to an external social network. When the button 2424 or 2426 is turned “On”, review information can be uploaded in the type of a posting material, which is provided by the social network, so that followers of the social network can watch the review information.

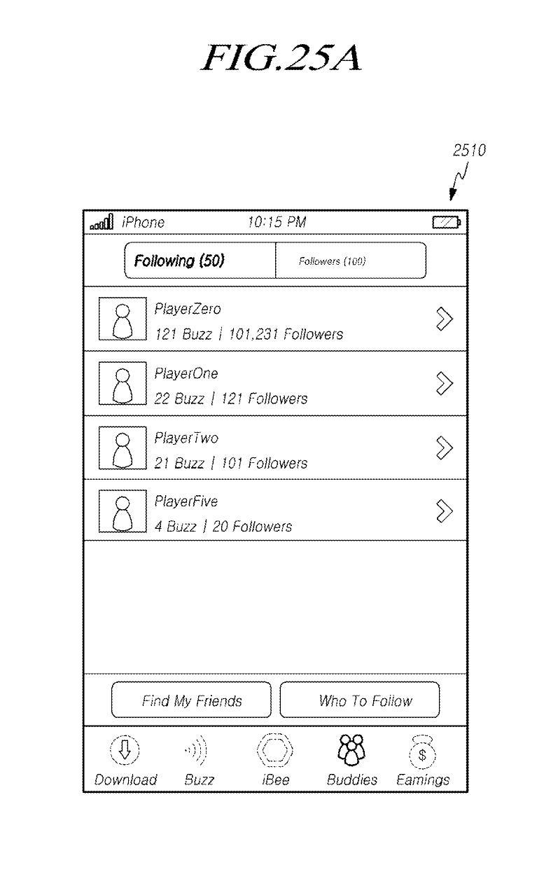

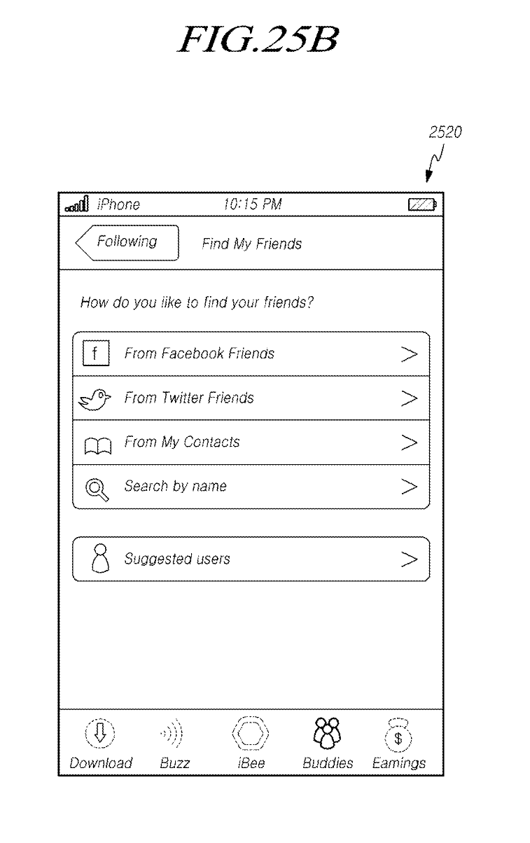

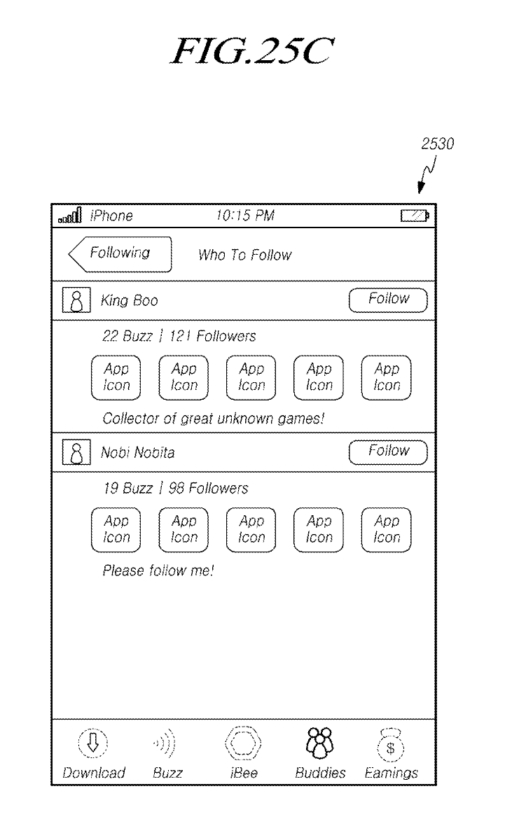

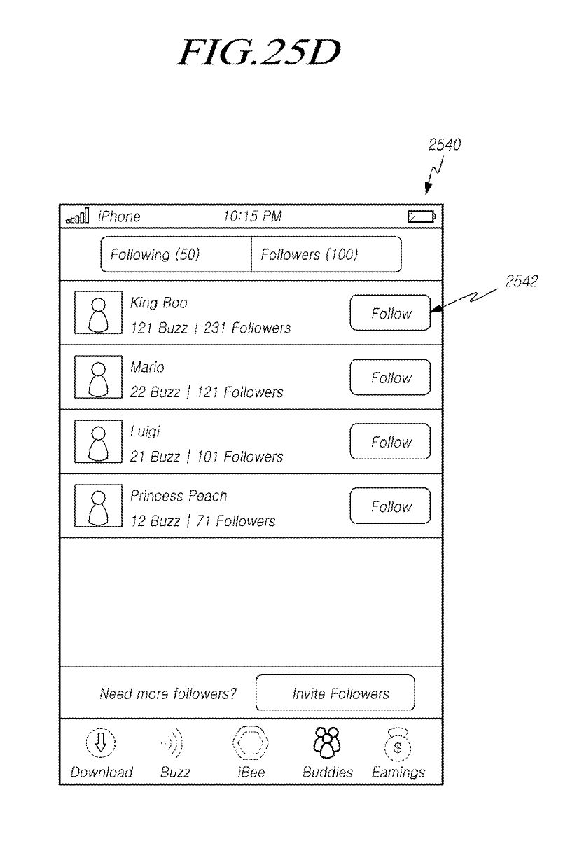

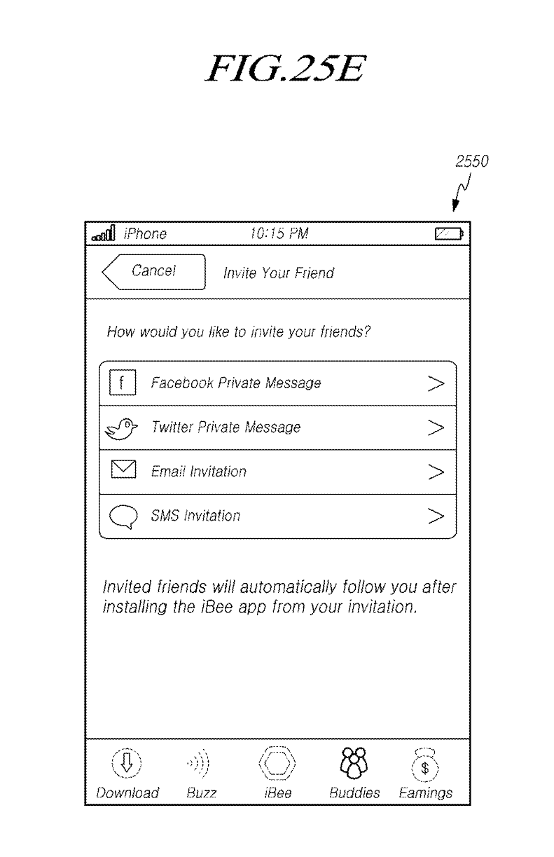

FIGS. 25A, 25B, 25C, 25D, and 25E illustrate a process of controlling buddy information using iBee App according to an embodiment of the present invention.

The screen 2510 of FIG. 25A displays users (“Following”), from whom the logged-in user wants to receive information. In the case of iBee network, there can be a distinction between users (“Following”), from which review information is to be received, and users (“Followers”) who want to receive review information of the user. It is also possible to allow review information to be watched by both sides, without such a distinction.

Firstly, when there is a distinction between “Following” and “Follower”, the user can subscribe to or check out review information of users included in the Following list. Review information written by the user is provided to users included in the Follower list.

Secondly, when review information can be watched from both sides, the user can list up and check out review information of all users added as buddies, and review information written by the user can also be provided to buddies. The type of construction of relationship between users can be selected according to the implementation scheme.

The screen 2520 of FIG. 25B shows an example of user searching for adding an external SNS user or a user inside iBee network as a friend or to include him/her in the Following list. The screen 2530 of FIG. 25C enables selection of a user to be included in the Following list according to standards provided by iBee network. The section “Who To Follow”, which recommends selection of buddies or users to be followed, can also make recommendations using a predetermined algorithm inside the network. In this case, the configuration can be based on the user's application preferences: for example, in the case of a user who likes games, marketers who create a lot of game review information or who provide high-quality game review information, can be recommended. In the case of a user who has installed a lot of games of a specific genre, e.g. puzzle games, marketers who create a lot of review information regarding the puzzle games or who provide high-quality puzzle game review information, can be recommended.

The screen 2540 of FIG. 25D displays users included in the Follower list, who subscribe to review information created by the user. The Following button 2542 can be selected to choose a user to be added to the Following list.

The screen 2550 of FIG. 25E enables invitation of users having a friend/buddy/following/follower relationship in an external SNS to use the iBee application.

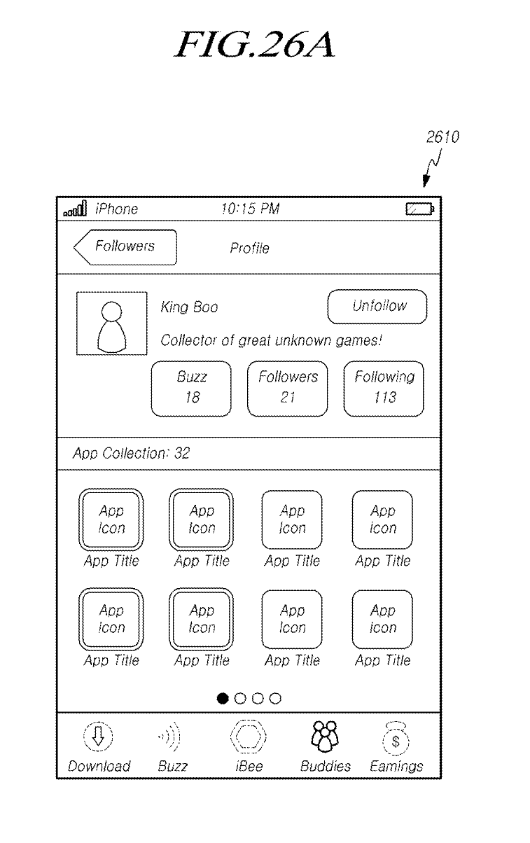

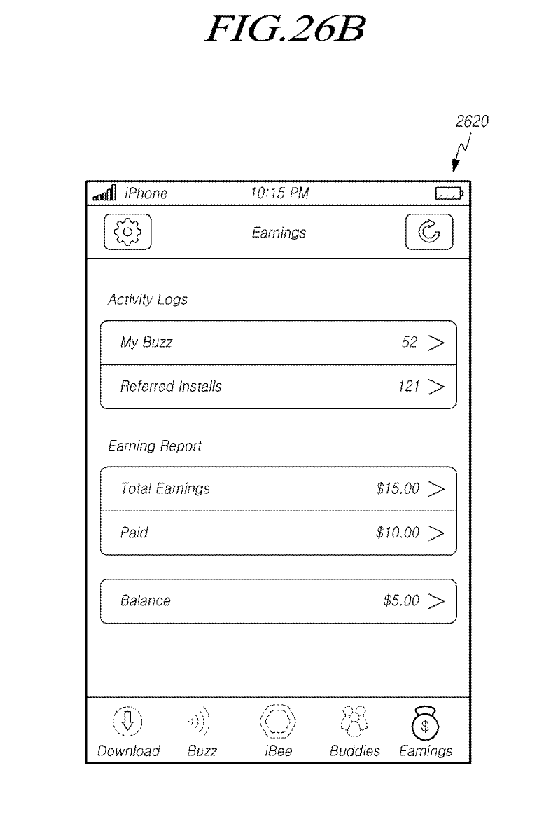

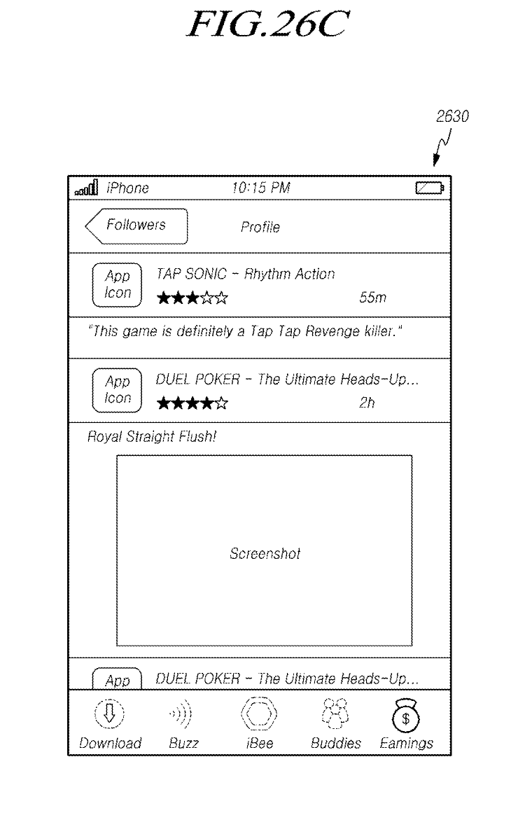

FIGS. 26A, 26B, and 26C illustrate checkout of personal information by iBee App according to an embodiment of the present invention.

The screen 2610 of FIG. 26A shows review information (Buzz) written by a specific user, buddies (Following/Follower), and apps installed or marketed by the corresponding user.

The screen 2620 of FIG. 26B provides review information (My Buzz) created by the logged-in user, the number of app installations (Referred Installs) generated using the review information, and information regarding earnings (Earning Reports) resulting from app installations based on the review information.

The screen 2630 of FIG. 26C lists up and shows reviews created by the logged-in user, when the reviews are sorted in the order of time.

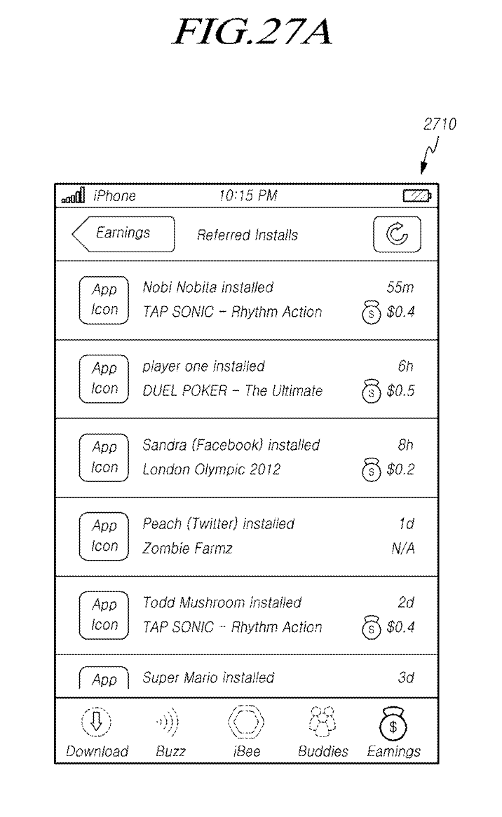

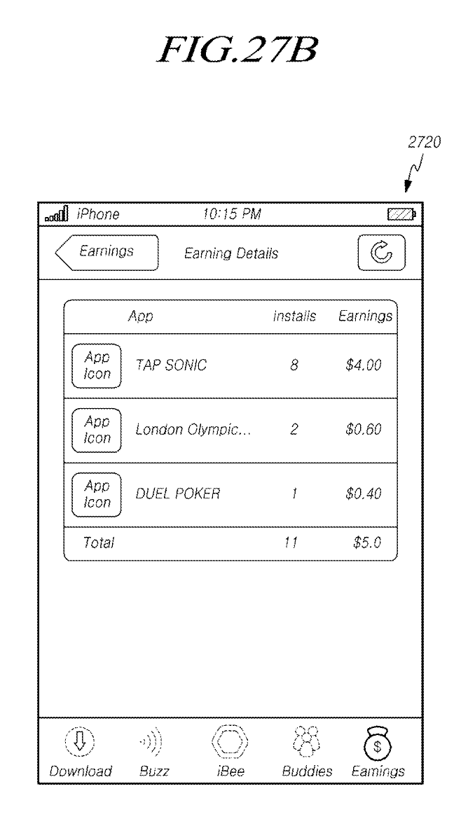

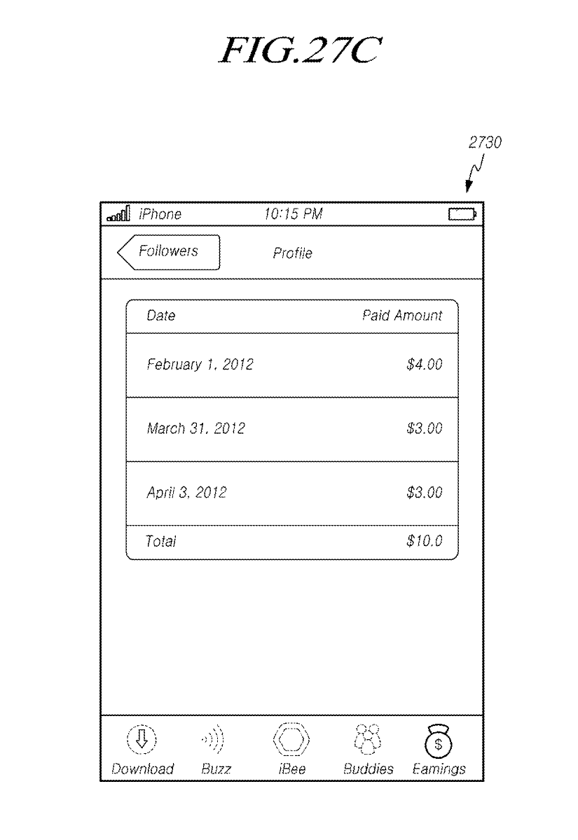

FIGS. 27A, 27B, and 27C illustrate checkout of a reward for review information by iBee App according to an embodiment of the present invention.

The screen 2710 of FIG. 27A shows a result of rewarding for review information (buzz) regarding each application created by the logged-in user.

The screen 2720 of FIG. 27B shows information regarding a reward for each app created by the logged-in user, particularly detained information regarding top three apps, downloads of which have earned the most money.

The screen 2730 of FIG. 27C shows information regarding a reward for each app created by the logged-in user, particularly information regarding the actual amount of reward paid.

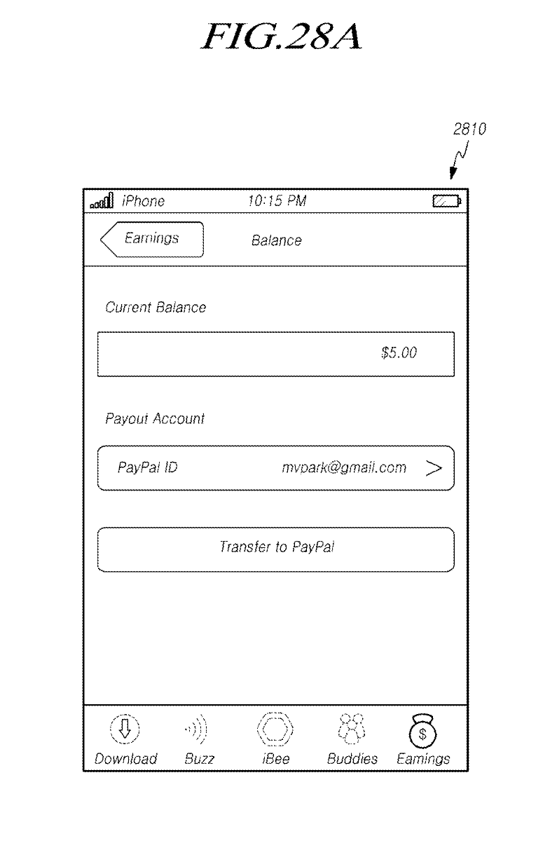

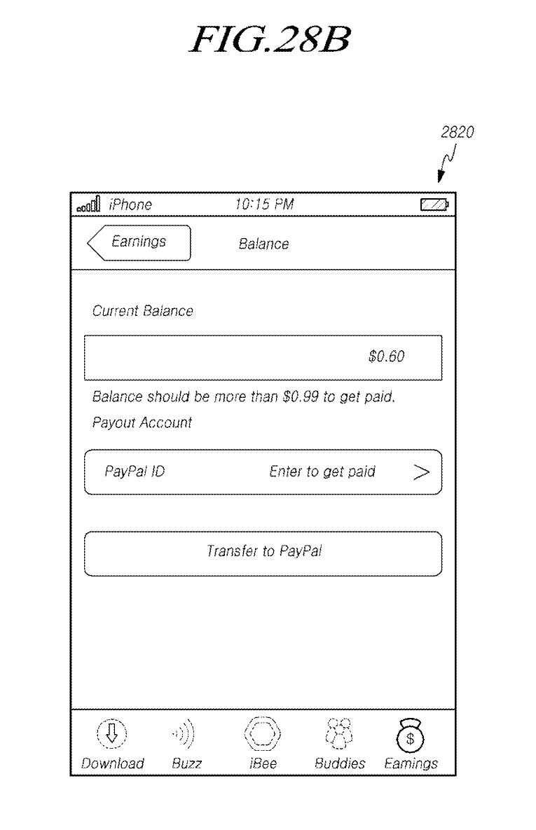

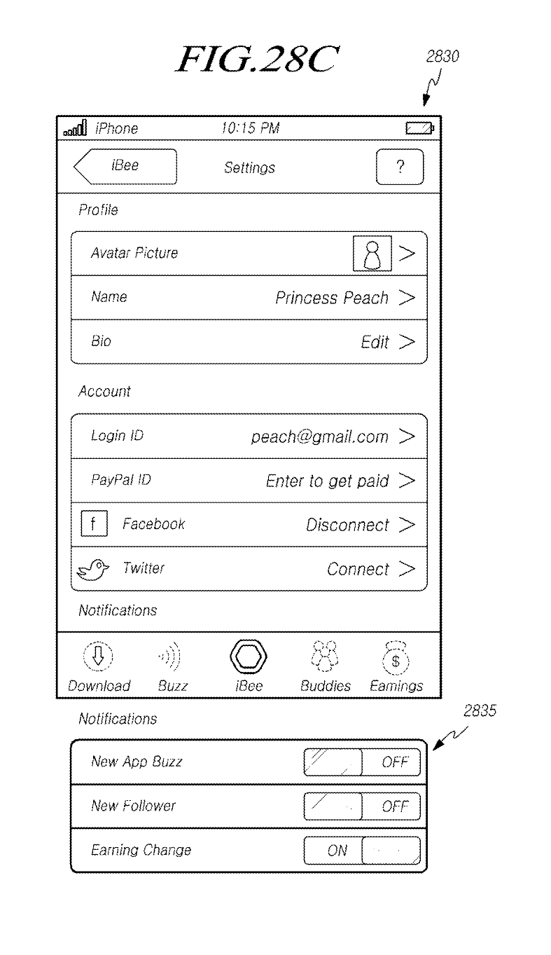

FIGS. 28A, 28B, and 28C illustrate payout of a reward for review information by iBee App according to an embodiment of the present invention.

Specifically, FIGS. 28A, 28B, and 28C illustrate a process of transferring reward money to a virtual account connected to a real bank account. The screen 2810 of FIG. 28A shows transfer of reward money for review information, which has been created so far, to account information, i.e. PayPal ID.

The screen 2820 of FIG. 28B shows a case in which the accumulated reward money is below a predetermined minimum balance, so no reward money can be transferred. Such criteria regarding accumulated reward money can be set by iBee network or by the company who manages the account information.

The screen 2830 of FIG. 28C shows the marketer's personal information settings, including settings of login information, interlinked account information, external SNS information, notification type 2835, etc.

According to the present invention, when a review regarding a mobile application is checked out, and then the mobile application is installed or executed, the review writer is rewarded for the marketing. Although installation or execution of a mobile application has been regarded as the criteria of rewarding in the above description, the present invention is not limited thereto, and, besides execution/installation, any information indicating use of the mobile application can be reflected. For example, upgrade of the mobile application or use of a specific function can also be reflected as a fact indicating use of the mobile application.

A mobile application marketing method according to an embodiment of the present invention has been described above.

The above-mentioned mobile application marketing method according to an embodiment of the present invention can be executed by an application (which can be a program included in or compatible with a platform or operating system mounted on the terminal by default) installed on the terminal 100 by default, or executed by an application (i.e. program) manually installed on the terminal 100 by the user through an application provider server (e.g. an application store server, a web server associated with the application or the corresponding service) and compatible with the operating system of the terminal 100. The operating system of the terminal 100 is either an operating system installed on conventional PCs (e.g. desktops), such as Windows, Macintosh, etc. or a mobile-dedicated operating system installed on mobile terminals (e.g. smart phones, tablet PCs), such as iOS, Android, etc.

In this sense, the mobile application marketing method according to an embodiment of the present invention can be implemented as an application (i.e. program) installed on the terminal 100 by default or manually installed by the user and recorded on a recording medium readable by a computer, such as the terminal 100.

A program implementing the mobile application marketing method according to an embodiment of the present invention executes each function of the process presented in FIGS. 12-16. Besides this, the program can execute all functions corresponding to the mobile application marketing method according to an embodiment of the present invention described with reference to FIGS. 1-10.

Such a program can be recorded on a non-transitory computer-readable recording medium such as ROMs, RAMs, CD-ROMs, magnetic tape, floppy disks, optical media storage devices, etc. and executed by a computer to execute the above-mentioned functions.

As such, in order for a computer to read the program, which is recorded on a recording medium, and execute a method for implementing marketing according to an embodiment of the present invention, which is implemented as the program, the above-mentioned program can include a code encoded by computer languages, such as C, C++, JAVA, machine languages, which can be read by a computer processor (CPU).

Such a code can include a function code related to functions, etc., which define the above-mentioned functions, and can also include an execution procedure-related control code necessary for a computer processor to execute the above-mentioned functions according to a predetermined procedure.

In addition, such a code can further include a memory reference-related code regarding in which position (address) of an internal or external memory of a computer should additional information or media, which is necessary for a computer processor to execute the above-mentioned functions, be referenced.

Furthermore, when communication with another computer or server at a remote location is necessary for a computer processor to execute the above-mentioned functions, the code can further include a communication-related code regarding how the computer processor should communicate with the other computer or server at a remote location using a communication module (e.g. wired and/or wireless communication module) of the computer, or what information or media needs to be transmitted/received during communication.

Furthermore, a functional program for implementing the present invention and a code and a code segment related with it can be easily inferred or modified by programmers in the technical field of the present invention, by considering the system environment, etc. of the computer that reads a recording medium and executes the program.

In addition, a computer-readable recording medium, in which the above-mentioned program is recorded, can be distributed over a system of computers connected via a network, so that a computer-readable code can be stored and executed in a distributed manner. In this case, at least one of a number of distributed computers can execute some of the functions presented above; the execution result can be transmitted to at least one of the other distributed computers; and the computer, which has received the result, can also execute some of the functions presented above and provide other distributed computers with the result.

Examples of a computer-readable recording medium, in which a program for executing a method for implementing marketing of a mobile application according to an embodiment of the present invention, as described above, is recorded, include ROMs, RAMs, CD-ROMs, magnetic tape, floppy disks, optical media storage devices, etc.

In addition, a computer-readable recording medium, in which a program (application) for executing a method for implementing marketing of a mobile application according to an embodiment of the present invention is recorded, can be a storage medium (e.g. hard disk) included in an application provider server, including an application store server, a web server related to the application or corresponding service, etc.; can be the application provider server itself; or can be another computer, in which the program is recorded, or its recording medium.

A computer capable of reading a recording medium, in which a program (application) for executing a method for implementing marketing of a mobile application according to an embodiment of the present invention is recorded, includes not only a conventional PC, such as a conventional desktop or laptop, but also a mobile terminal, such as a smart phone, a tablet PC, a PDA (Personal Digital Assistant), and a mobile communication terminal, and should also be interpreted as any device capable of computing.

If the computer capable of reading a recording medium, in which a program (application) for executing a method for implementing marketing of a mobile application according to an embodiment of the present invention is recorded is a mobile terminal, such as a smart phone, a tablet PC, a PDA (Personal Digital Assistant), and a mobile communication terminal, the mobile terminal can download and install the corresponding application from an application provider server, including an application store server, a web server, etc.; and, if necessary, the application can be downloaded from the application provider server to a conventional PC and then installed on the mobile terminal through a synchronization program.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, or the like may be employed as the storage medium of the computer program.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. An application marketing method comprising the steps of:
receiving, by a marketing server, review information regarding an application from a first terminal and storing the received review information together with identification information regarding the application and identification information regarding a marketer who has logged into the first terminal;
installing, by a second terminal, the application included in the review information based on the stored review information; and
performing, by the marketing server, a process of rewarding the marketer corresponding to the identification information for installation of the application.

2. A mobile application marketing method comprising the steps of:
receiving, by a marketing server, review information regarding a mobile application from a first mobile terminal;
storing, by the marketing server, the received review information, identification information regarding the mobile application, and identification information regarding a marketer who has logged into the first mobile terminal;
transmitting, by the marketing server, the review information to a second mobile terminal which requests the review information;
receiving, by the marketing server, a message indicating that the mobile application has been installed on the second mobile terminal; and
performing, by the marketing server, a process of rewarding the marketer for installation of the mobile application.

3. The mobile application marketing method as claimed in claim 2, further comprising, after the step of transmitting the review information, a step of storing, by the marketing server, identification information regarding the second mobile terminal and the marketer identification information.

4. The mobile application marketing method as claimed in claim 2, wherein the step of transmitting the review information to the second mobile terminal comprises the steps of:
transmitting, by the marketing server, at least two pieces of identification information regarding at least two pieces of review information regarding the mobile application;
receiving, by the marketing server, one of the at least two pieces of identification information regarding at least two pieces of review information from the second mobile terminal; and
transmitting, by the marketing server, the review information corresponding to the received identification information to the second mobile terminal.

5. The mobile application marketing method as claimed in claim 4, wherein the step of transmitting at least two pieces of identification information regarding at least two pieces of review information comprises a step of sorting, by the marketing server, the at least two pieces of identification information regarding at least two pieces of review information in such an order that review information written by a marketer having a high engagement level of the mobile application comes first and transmitting the sorted information.

6. The mobile application marketing method as claimed in claim 4, wherein the step of transmitting at least two pieces of identification information regarding at least two pieces of review information comprises a step of sorting the at least two pieces of identification information regarding at least two pieces of review information in such an order that review information having a large recommendation number comes first and transmitting the sorted information.

7. A mobile application marketing method comprising the steps of:
transmitting, by a first mobile terminal, review information regarding a mobile application to a marketing server;
receiving, by the first mobile terminal, a message from the marketing server, after the mobile application is installed on a second mobile terminal which has requested the review information, the message including information regarding a reward for installation of the mobile application; and
receiving, by the first mobile terminal, a result of performing a rewarding process based on the reward from the marketing server.

8. The mobile application marketing method as claimed in claim 7, wherein the review information is one of the at least two pieces of review information regarding the mobile application written by a marketer having a high engagement level of the mobile application.

9. A mobile application marketing method comprising the steps of:
receiving, by a mobile terminal, review information regarding a mobile application from a marketing server; and
installing, by the mobile terminal, the mobile application included in the received review information, wherein
the marketing server performs a process of rewarding a marketer, who has written the review, for installation of the mobile application.

10. The mobile application marketing method as claimed in claim 9, further comprising, before the step of receiving the review information, the steps of:
receiving, by the mobile terminal, at least two pieces of identification information regarding at least two pieces of review information regarding the mobile application from the marketing server; and
transmitting, by the mobile terminal, one of the at least two pieces of identification information regarding at least two pieces of review information to the marketing server.

11. The mobile application marketing method as claimed in claim 10, wherein the step of receiving at least two pieces of identification information regarding at least two pieces of review information comprises a step of sorting the at least two pieces of identification information regarding at least two pieces of review information in such an order that review information written by a marketer having a high engagement level of the mobile application comes first and receiving the sorted information by the mobile terminal.

12. The mobile application marketing method as claimed in claim 10, wherein the step of receiving at least two pieces of identification information regarding at least two pieces of review information comprises a step of sorting the at least two pieces of identification information regarding at least two pieces of review information in such an order that review information having a large recommendation number comes first and receiving the sorted information.

13. A marketing server comprising:
a reception unit adapted to receive review information regarding a mobile application from a first mobile terminal;
a database unit adapted to store the received review information, identification information regarding the mobile application, and identification information regarding a marketer who has logged into the first mobile terminal;
a transmission unit adapted to transmit the review information to a second mobile terminal which requests the review information; and
a control unit adapted to perform a process, when the reception unit receives a message indicating that the mobile application has been installed on the second mobile terminal, of rewarding the marketer for installation of the mobile application.

14. A mobile terminal comprising:
a transmission unit adapted to transmit review information regarding a mobile application to a marketing server;
a reception unit adapted to receive a message from the marketing server, after the mobile application is installed on a second mobile terminal which has requested the review information, the message comprising information regarding a reward for installation of the mobile application; and
a control unit adapted to control the transmission unit and the reception unit, wherein
the control unit is adapted to control the reception unit so as to receive a result of performing a rewarding process based on the reward from the marketing server.

15. A mobile terminal comprising:
a reception unit adapted to receive at least two pieces of identification information regarding at least two pieces of review information regarding a mobile application from a marketing server;
a transmission unit adapted to transmit one of the at least two pieces of identification information regarding at least two pieces of review information to the marketing server; and
a control unit adapted to control so that, when the reception unit receives review information regarding the mobile application from the marketing server, the mobile application included in the received review information is installed, wherein
the marketing server performs a process of rewarding a marketer, who has written the review, for installation of the mobile application.

16. A non-transitory computer-readable recording medium in which a program for executing the method as claimed claim 1.
